(19) United States
(12) Patent Application Publication
(10) Pub. No.: US 2011/0118034 A1
(43) Pub. Date: May 19, 2011

(54) IMMERSIVE WAGERING GAME MACHINE LIGHTING STRUCTURES

(75) Inventors: Joel R. Jaffe, Glenview, IL (US); Paul M. Lesley, Blue Island, IL (US); Scott A. Massing, Lincolnwood, IL (US); Eric M. Pryzby, Skokie, IL (US); Alfred Thomas, Las Vegas, NV (US); Martin R. Ugarte, Chicago, IL (US)

(73) Assignee: MWS Gaming, Inc., Waukegan, IL (US)

(21) Appl. No.: 12/945,815

(22) Filed: Nov. 12, 2010

Related U.S. Application Data
(60) Provisional application No. 61/261,131, filed on Nov. 13, 2009.

(51) Int. Cl. A63F 13/02; A63F 13/00

(52) U.S. Cl. 463/42; 463/47

(57) ABSTRACT

A lighting controller can be configured to control a variety of immersive lighting structures proximate to a wagering game machine (e.g., surrounding, affixed to, flanking, etc.) in accordance with game events (e.g., the wagering game being played, a bonus game, a portal game, etc.) and/or non-game events (e.g., emergency notifications, non-emergency casino announcements, etc.). The lighting controller can control the immersive lighting structure for a single wagering game machine and/or immersive lighting structures of multiple wagering game machines to produce light effects based on a lighting scheme that corresponds to a game event or non-game event.

### RELATED APPLICATIONS

This application claims the priority benefit of U.S. Provisional Application Ser. No. 61/261,131 filed Nov. 13, 2009.

### LIMITED COPYRIGHT WAIVER

A portion of the disclosure of this patent document contains material, which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2010, WMS Gaming, Inc.

### FIELD

Embodiments of the inventive subject matter relate generally to wagering game systems, and more particularly to controlling lighting on wagering game systems in accordance with wagering game events.

### BACKGROUND

Lighting on wagering game machines is typically configured to increase excitement associated with game play on the wagering game machine. The lighting on the wagering game machines is typically part of the cabinet of the wagering game machine. Wagering game machines vary the lighting, for example flashing lights, in a periodic or seemingly random manner.

### BRIEF DESCRIPTION OF THE FIGURES

Embodiments of the invention are illustrated in the Figures of the accompanying drawings in which:

FIG. 1A depicts an angled front view of a bank of three wagering game machines with immersive lighting structures according to a first embodiment.

FIG. 1B depicts a top view of the bank of three wagering game machines with the immersive lighting structures according to the first embodiment.

FIG. 2A depicts an angled front view of a bank of three wagering game machines with immersive lighting structures according to a second embodiment.

FIG. 2B depicts a top view of the bank of three wagering game machines with the immersive lighting structures according to the second embodiment.

FIG. 3A depicts an angled front view of a bank of three wagering game machines with immersive lighting structures according to a third embodiment.

FIG. 3B depicts a top view of the bank of three wagering game machines with the immersive lighting structures according to the third embodiment.

FIG. 4A depicts a fourth embodiment of an angled front view of a bank of three wagering game machines with immersive lighting structures.

FIG. 4B depicts a top view of the fourth embodiment of the bank of three wagering game machines with the immersive lighting structures.

FIG. 5 illustrates wagering game machines comprising lighting influenced by game-based events on the wagering game machines.

FIG. 6 illustrates an example wagering game machine comprising integrated lighting structures.

FIG. 7 depicts an example illustration of a pedestal with integrated lighting.

FIG. 8 is a conceptual diagram illustrating game-based control of wagering game machine lighting.

FIG. 9 is a flow diagram illustrating example operations for controlling wagering game machine lighting in accordance with game-based events.

FIG. 10 is a flow diagram illustrating example operations for synchronizing lighting across multiple wagering game machines.

FIG. 11 is a block diagram illustrating a wagering game network, according to example embodiments of the invention.

FIG. 12 is a block diagram illustrating wagering game machine architecture, according to example embodiments of the invention.

### DESCRIPTION OF THE EMBODIMENTS

The description that follows includes exemplary systems, methods, techniques, instruction sequences, and computer program products that embody techniques of the present inventive subject matter. However, it is understood that the described embodiments may be practiced without these specific details. For instance, although examples select lighting schemes based on wagering game based events and player preferences, lighting schemes can be created on-the-fly based on default schemes and current activity data for a player and/or the wagering game establishment (e.g., player density, status of lighting structures, etc.). In other instances, well-known instruction instances, protocols, structures, and techniques have not been shown in detail in order not to obfuscate the description.

Although lighting structures built into a wagering game machine can be manipulated to excite a player (e.g., flashing lights upon a win event), these built-in lighting structures are limited. In addition, the built-in lighting structures can possibly interfere with game play experience due to proximity to the display. A casino may use separate scaffold lighting or video displays, but the display and scaffold lighting are generic, and, thus, lack a meaningful nexus with the wagering games. Moreover, their placement can mute intended effects upon players.

Immersive lighting structures can be built that surround and/or attach to wagering game machines. The immersive lighting structures surrounding and/or attached to the wagering game machines create an immersive lighting effect at the wagering game machines. The immersive lighting structures can be arranged to diffuse light from a light source, cast light onto areas adjacent to the wagering game machine, reflect light onto the wagering game machines and/or player, etc. The immersive lighting structures can also be configured to manipulate light from light sources that are not part of the immersive lighting structures (e.g., light sources built-into the wagering game machines, nearby light sources, etc.). Furthermore, the immersive lighting structure can be configurable to allow light effects of the immersive lighting structure to be changed. For instance, the immersive lighting structure can be constructed to allow elements to be arranged differently, swapped out, removed, etc.

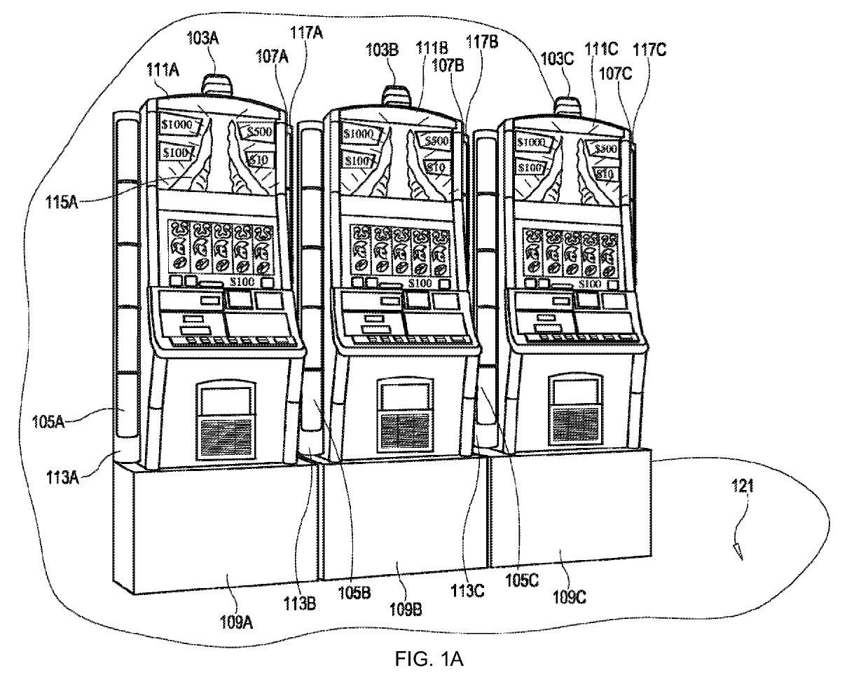

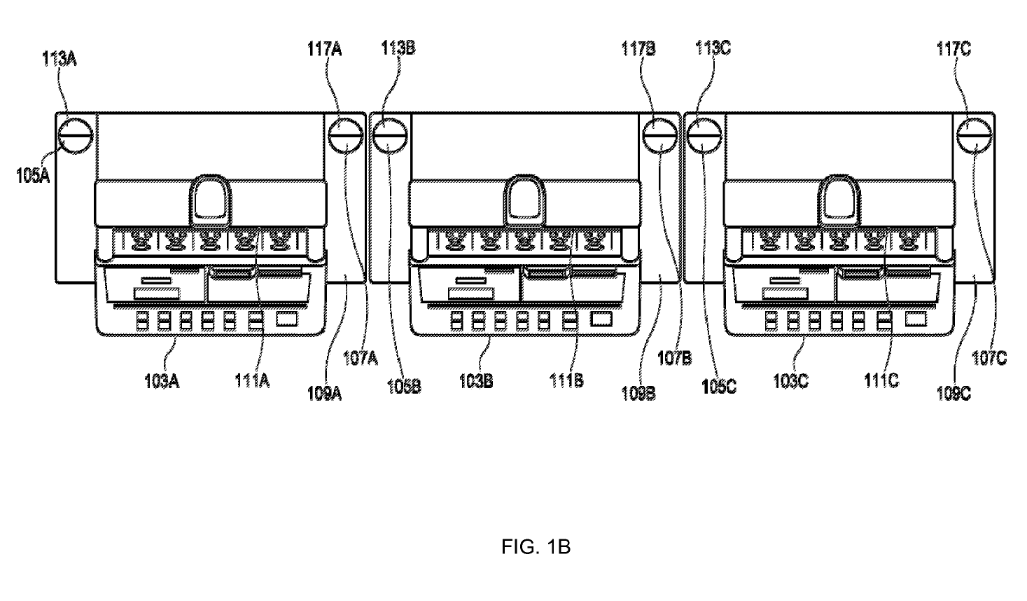

FIGS. 1A and 1B depict different views of an embodiment of a bank of three wagering game machines with immersive lighting structures. FIG. 1A depicts an angled front view of the bank of three wagering game machines with the immersive lighting structures. FIG. 1B depicts a top view of the bank of three wagering game machines with the immersive lighting structures. The immersive lighting structures flank each of the wagering game machines 103A, 103B, and 103C.

FIG. 1B illustrates the elements of the immersive lighting structures. The immersive lighting structure that flanks the wagering game machine 103A comprises light source elements 105A, 107A. FIG. 1B depicts the light source elements 105A and 107A as circular from a top view. FIG. 1A depicts the light source element 105A as constructed within a support structure 113A that comprises a cavity adapted to house the light source element 105A. The support structure 113A is mounted on a pedestal 109A, that supports the wagering game machine 103A. The support structure 113A is mounted on the pedestal 109A at the left rear corner of the wagering game machine 103A, from the perspective of a player facing the wagering game machine 103A. FIG. 1B depicts the support structure 113A as semicircular in shape with a semicircular cavity to house the light source element 105A. One half of the light source element 105A fits into the cavity of the support structure 113A, while the other half of the light source element 105A (that faces the player) protrudes from the support structure 113A. FIG. 1A also depicts the light source element 105A as a cylindrical light source element that stands at a height near the height of the wagering game machine 103A. FIG. 1B depicts the light source element 107A as constructed within a support structure 117A that comprises a cavity to house the light source element 107A. The support structure 117A is mounted on the pedestal 109A at the right, rear corner of the wagering game machine 103A, from the perspective of the player facing the wagering game machine 103A. The support structure 117A is semicircular in shape with a semicircular cavity to house the light source element 107A.

FIG. 1A depicts a light source element 111A integrated into the top of the wagering game machine 103A above a secondary display 115A. The light source element 111A runs horizontally across the wagering game machine 103A. FIG. 1A depicts the light source element 111A as slightly curved across the top. The lighting structure that flanks the wagering game machine 103A can be created to be similar to the integrated light source element 111A. In addition, the lighting structure light source elements 105A, 107A can be manipulated in coordination with the light source element 111A.

FIG. 1B depicts the immersive lighting structure that flanks the wagering game machine 103B as comprising light source elements 105B, 107B. The light source elements 105B and 107B are circular from a top view. FIG. 1A depicts the light source element 105B as constructed within a support structure 113B that comprises a cavity to hold the light source element 105B. The support structure 113B is mounted on a pedestal 109B, that supports the wagering game machine 103B. The support structure 113B is mounted on the pedestal 109B at the left rear corner of the wagering game machine 103B, from the perspective of a player facing the wagering game machine 103B. FIG. 1B depicts the support structure 113B as semicircular in shape with a semicircular cavity to hold the light source element 105B. As indicated in FIG. 1A, one half of the light source element 105B fits into the cavity of the support structure 113B, while the other half of the light source element 105B (that faces the player) protrudes from the support structure 113B. FIG. 1A also depicts the light source element 105B as a cylindrical light source element that stands at a height near the height of the wagering game machine 103B. FIG. 1B depicts the light source element 107B as constructed within a support structure 117B that comprises a cavity to hold the light source element 107B. The support structure 117B is mounted on the pedestal 109B at the right, rear corner of the wagering game machine 103B, from the perspective of a player facing the wagering game machine 103B. The support structure 117B is semicircular in shape with a semicircular cavity to hold the light source element 107B. One half of the light source element 107B fits into the cavity of the support structure 117B, while the other half of the light source element 107B (that faces the player) protrudes from the support structure 117B.

FIG. 1A depicts the light source element 111B as integrated into the top of the wagering game machine 103B above a secondary display 115B. The light source element 111B runs horizontally across the top of the wagering game machine 103B. FIG. 1A depicts the light source element 115B as slightly curved across the top. The lighting structure that flanks the wagering game machine 103B can be created to be similar to the integrated light source element 111B. In addition, the lighting structure light source elements 105B, 107B can be manipulated in coordination with the light source element 111B.

FIG. 1B depicts the immersive lighting structure that flanks the wagering game machine 103C as comprising light source elements 105C, 107C. The light source elements 105C and 107C are circular from a top view. The light source element 105C is constructed within a support structure 113C that comprises a cavity to hold the light source element 105C. The support structure 113C is mounted on a pedestal 109C that supports the wagering game machine 103C. The support structure 113C is mounted on the pedestal 109C at the left rear corner of the wagering game machine 103C, from the perspective of a player facing the wagering game machine 103C. The support structure 113C is semicircular in shape and comprises a semicircular cavity to hold the light source element 105C. FIG. 1A depicts the light source element 105C as a cylindrical light source element that stands at a height near the height of the wagering game machine 103C. FIG. 1B depicts the light source element 107C as constructed within a support structure 117C that comprises a cavity to hold the light source element 107C. The support structure 117C is mounted on the pedestal 109C at the right, rear corner of the wagering game machine 103C from the perspective of the player facing the wagering game machine 103C. The support structure 117C is semicircular in shape and comprises a semicircular cavity to hold the light source element 107C.

FIG. 1A depicts the light source element 111C as integrated into the top of the wagering game machine 103C above a secondary display 115C. The light source element 111C runs horizontally across the wagering game machine 103C. FIG. 1A depicts the light source element 115C as slightly curved across the top. The lighting structure that flanks the wagering game machine 103C can be created to be similar to the integrated light source element 111C. In addition, the lighting structure light source elements 105C, 107C can be manipulated in coordination with the light source element 111C.

In embodiments, the elements of the lighting structures can be arranged differently, can be removed, can be moved, can be adjusted, etc. The elements can be also made in a variety of shapes and sizes. As depicted in FIG. 1A, the immersive lighting structures illuminate an area 121 around the wagering game machines 103A, 103B, 103C. The light source elements 105A, 107A, 111A, 105B, 107B, 111B, 105C, 107C, and 111C of the lighting structures collectively emit light to create an aura of light around the wagering game machines. FIG. 1A depicts the illuminated area 121 on the floor below the bank of the three wagering game machines 103A, 103B, and 103C. The illuminated area 121 may be created by strategically positioning light source elements to face the rear face of the wagering game machines. For example, a light source element may be placed behind the wagering game machine 103C (e.g., in the pedestal 109C of the wagering game machine 103C), at an angle so that the light source element faces the rear right corner of the wagering game machine 103C, etc.

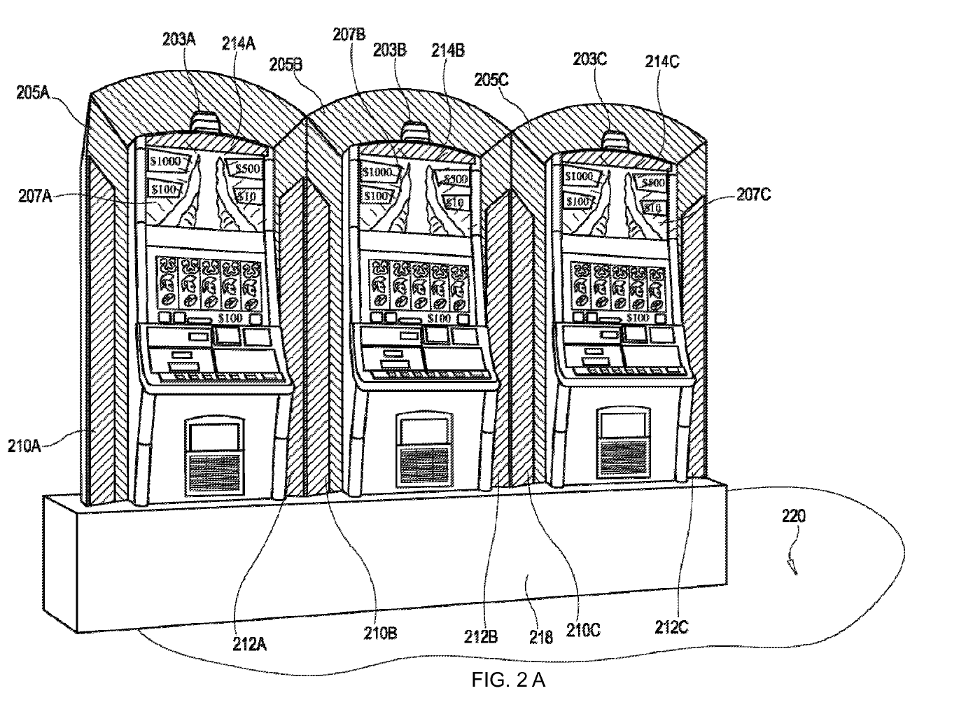

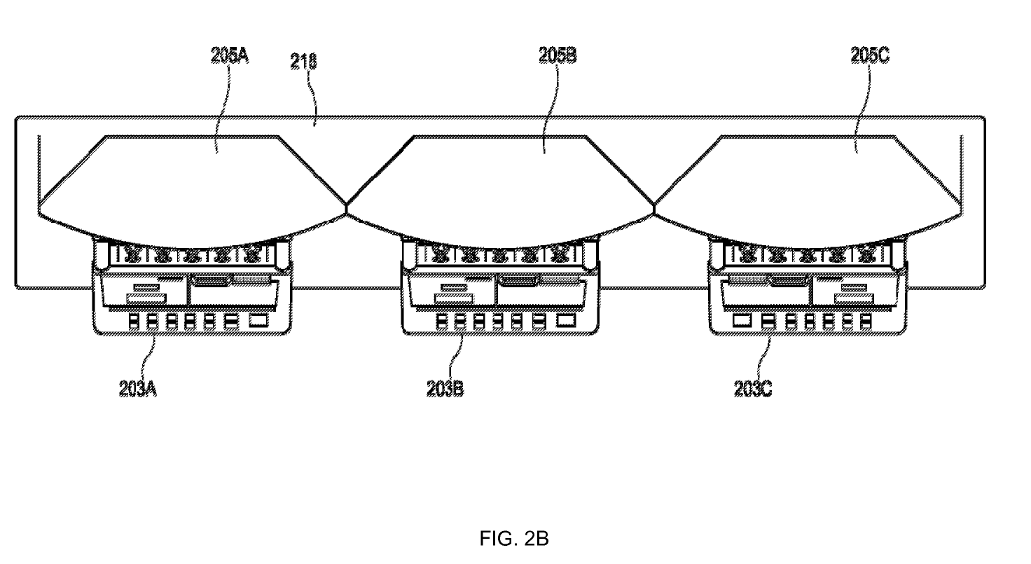

FIGS. 2A and 2B depict different views of a bank of three wagering game machines with immersive lighting structures according to a second embodiment. FIG. 2A depicts an angled front view of the bank of three wagering game machines with the immersive lighting structures according to the second embodiment. FIG. 2B depicts a top view of the bank of three wagering game machines with the immersive lighting structures according to the second embodiment. Immersive lighting structures frame each of wagering game machines 203A, 203B, and 203C. The wagering game machines 201A, 201B, and 201C are mounted on a common pedestal 218.

FIG. 2A depicts the immersive lighting structure that frames the wagering game machine 203A as comprising a reflective element 205A. The reflective element 205A is mounted on the common pedestal 218. The reflective element 205A follows the shape of the wagering game machine 203A. The reflective element 205A has a rectangular shape extending from the base of the wagering game machine 203A to above the top of the wagering game machine 203A. The reflective element 205A is dome-shaped, curving over the top of the wagering game machine 203A.

FIG. 2B depicts the reflective element 205A as trapezoidal from a top view. A longest edge of the reflective element 205A faces a player and is slightly curved towards the player. The reflective element 205A entirely conceals the top view of the top portion of the wagering game machine. In FIG. 2A, the reflective element 205A comprises reflective elements 210A, 212A. The reflective element 210A is integrated onto the left face of the reflective element 205A, and the reflective element 212A is integrated onto the right face of the encapsulating reflective element 205A. The positions (e.g., left, right) of the reflective elements 210A and 212A are from the perspective of a player facing the wagering game machine 203A. The reflective elements 210A and 212A reflect light emitted from nearby light sources (e.g., from the wagering game machine 203A) and reflected off of other portions of the reflective structure 205A. The reflective elements 210A and 212A are made of a material and/or coated with a substance that reflects wavelengths of light differently than the other portions of the reflective element 205A. As depicted in FIG. 2A, light from a light source(s) (e.g., integrated into or attached to the back of the wagering game machine 203A) is reflected by the reflective element 205A and the reflective elements 210A and 212A to produce an aura of light around the wagering game machine 203A, including reflecting light onto an illuminated area 220.

A light source element 214A is integrated into the top of the wagering game machine 203A above a secondary display 207A. The light source element 214A runs horizontally across the wagering game machine 203A and is located above the secondary display 207A. The light source element 214A is slightly curved across the top. The reflective element 205A reflects light emitted from the light source 214A.

FIG. 2A depicts the immersive lighting structure that frames the wagering game machine 203B as comprising a reflective element 205B. The reflective element 205B is mounted on the common pedestal 218. The reflective element 205B follows the shape of the wagering game machine 203B. The reflective element 205B has a rectangular shape extending from the base of the wagering game machine 203B to above the top of the wagering game machine 203B. The reflective element 205B is dome-shaped, curving over the top of the wagering game machine 203B.

FIG. 2B depicts the reflective element 205B as trapezoidal from a top view. A longest edge of the reflective element 205B faces a player and is slightly curved towards the player. The reflective element 205B entirely conceals the top view of the top portion of the wagering game machine. In FIG. 2A, the reflective element 205B comprises reflective elements 210B, 212B. The reflective element 210B is integrated onto the left face of the reflective element 205B, and the reflective element 212B is integrated onto the right face of the encapsulating reflective element 205B. The positions (e.g., left, right) of the reflective elements 210B and 212B are from the perspective of a player facing the wagering game machine 203B. The reflective elements 210B and 212B reflect light emitted from nearby light sources (e.g., from the wagering game machine 203B) and reflected off of other portions of the reflective structure 205B. The reflective elements 210B and 212B are made of a material and/or coated with a substance that reflects wavelengths of light differently than the other portions of the reflective element 205B. As depicted in FIG. 2A, light from a light source(s) (e.g., integrated into or attached to the back of the wagering game machine 203B) is reflected by the reflective element 205B and the reflective elements 210B and 212B to produce an aura of light around the wagering game machine 203B, including reflecting light onto the illuminated area 220.

A light source element 214B is integrated into the top of the wagering game machine 203B above a secondary display 207B. The light source element 214B runs horizontally across the wagering game machine 203B, above the secondary display 207B. The light source element 214B is slightly curved across the top. The reflective element 205B reflects light emitted from the light source 214B.

FIG. 2A depicts the immersive lighting structure that frames the wagering game machine 203C as comprising a reflective element 205C. The reflective element 205C is mounted on the common pedestal 218. The reflective element 205C follows the shape of the wagering game machine 203C. The reflective element 205C has a rectangular shape extending from the base of the wagering game machine 203C to above the top of the wagering game machine 203C. The reflective element 205C is dome-shaped, curving over the top of the wagering game machine 203C.

FIG. 2B depicts the reflective element 205C as trapezoidal from a top view. A longest edge of the reflective element 205C faces a player and is slightly curved towards the player. The reflective element 205C entirely conceals the top view of the top portion of the wagering game machine. In FIG. 2A, the reflective element 205C comprises reflective elements 210C, 212C. The reflective element 210C is integrated onto the left face of the reflective element 205C, and the reflective element 212C is integrated onto the right face of the encapsulating reflective element 205C. As mentioned above, “left” and “right” are from the perspective of the player facing the bank of wagering game machines. The reflective elements 210C and 212C reflect light emitted from nearby light sources (e.g., from the wagering game machine 203C) and reflected off of other portions of the reflective structure 205C. The reflective elements 210C and 212C are made of a material and/or coated with a substance that reflects wavelengths of light differently than the other portions of the reflective element 205C. As depicted in FIG. 2A, light from a light source(s) (e.g., integrated into or attached to the back of the wagering game machine 203C) is reflected by the reflective element 205C and the reflective elements 210B and 212C to produce an aura of light around the wagering game machine 203C, including reflecting light onto the illuminated area 220.

The light source element 214C is integrated into the top of the wagering game machine 203C above a secondary display 207C. The light source element 214C runs horizontally across the wagering game machine 203C, above the secondary display 207C. The light source element 214C is slightly curved across the top. The reflective element 205C reflects light emitted from the light source 214C.

In embodiments, the elements of the lighting structures can be arranged differently, removed, moved, adjusted, made in various shapes and sizes, made to emit or reflect various colors, etc. The various possible arrangements and characteristics allow the lighting structures to produce various lighting effects around the bank of wagering game machines. As stated above, the lighting structures reflect light onto the area 220 to create an aura of light around the base of the common pedestal 218. The illuminated area 220 may be generated by strategically positioning light source elements to emit light from the rear and/or sides of the wagering game machines in addition to the light source elements 214A, 214B, and 214C. For example, the light source elements may be placed behind the wagering game machine 203C (e.g., in a cavity in the body of the wagering game machine 203C, in the pedestal 218 underneath the wagering game machine 203C, etc.) or may be an external light source located nearby (e.g., overhead displays, light sources on nearby columns, etc.).

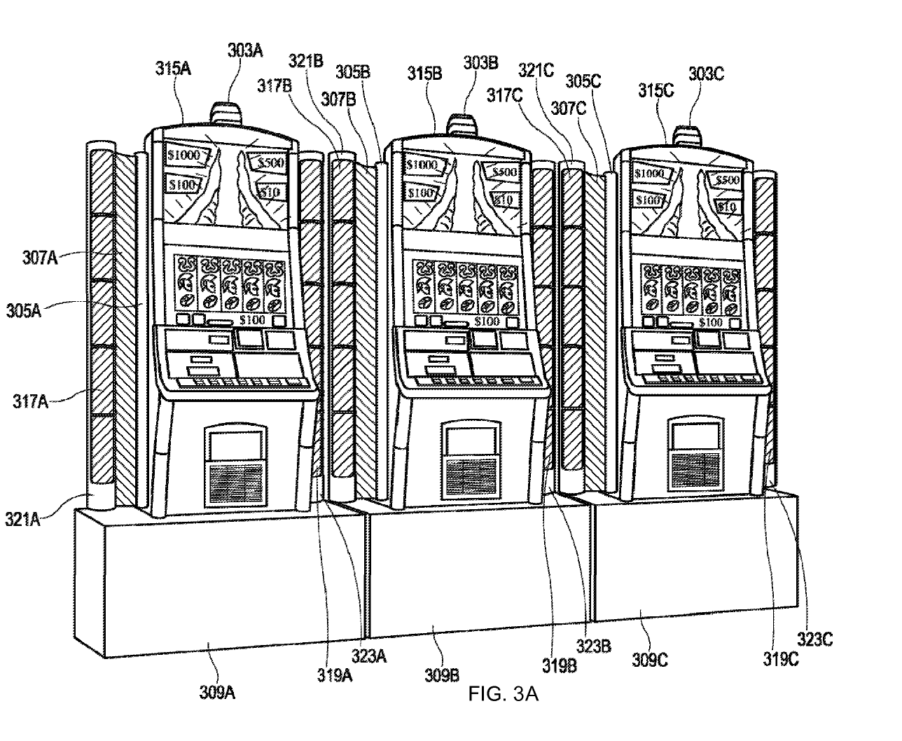

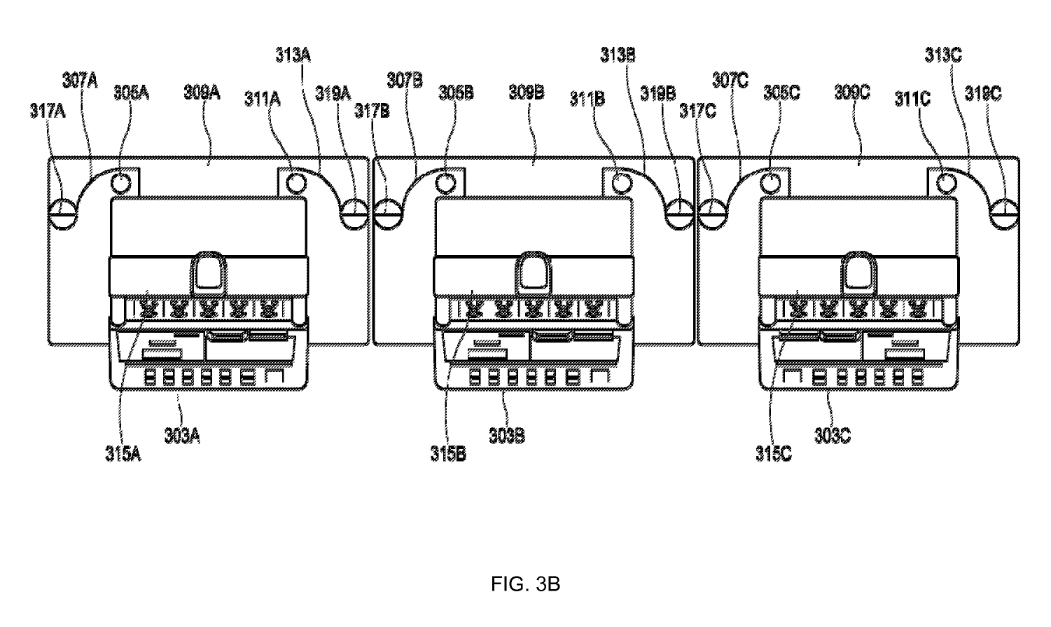

FIGS. 3A and 3B depict different views of a bank of three wagering game machines with immersive lighting structures. FIG. 3A depicts an angled front view of the bank of three wagering game machines with the immersive lighting structures according to a third embodiment. FIG. 3B depicts a top view of the bank of three wagering game machines with the immersive lighting structures according to the third embodiment. Immersive lighting structures flank wagering game machines 303A, 303B, and 303C.

FIG. 3B illustrates the immersive lighting structure that flanks the wagering game machine 303A as comprising light source elements 305A, 311A, 317A, and 319A, and reflective elements 307A and 313A. The light source elements 305A, 311A, and 317A and the reflective elements 307A and 313A are mounted on a pedestal 309A that supports the wagering game machine 303A. FIG. 3B depicts the light source elements 305A and 311A as circular from a top view. The light source element 305A is mounted on the pedestal 309A, at the left rear corner of the wagering game machine 303A. The light source element 311A is mounted on the pedestal 309A, at the left rear corner of the wagering game machine 303A. The reflective elements 307A and 313A are concave from a top view and an inner end of the reflective elements 307A and 313A is respectively affixed to the left and right edges of the wagering game machine 303A. The reflector elements 307A and 313A partially enclose the respective light source elements 305A and 311A. FIG. 3A depicts the light source element 305A as a cylindrical light source element that stands at a height near the height of the wagering game machine 303A. FIG. 3B depicts the light source elements 317A and 319A as semicircular from a top view. FIG. 3A depicts the light source element 317A as a cylindrical light source element that stands at a height near the height of the wagering game machine 103A. The light source element 317A is constructed within a support structure 321A that comprises a semicircular cavity to hold the light source element 317A. In FIG. 3A, the support structure 321A is mounted on the pedestal 309A, at the left edge of the wagering game machine 303A in line with the base of the wagering game machine 303A. FIG. 3B depicts the support structure 321A as affixed to the outer edge of the reflector element 307A.

The light source element 319A is constructed within a support structure 323A that comprises a semicircular cavity to hold the light source element 319A. The support structure 323A is mounted on the pedestal 309A, at the right edge of the wagering game machine 303A in line with the base of the wagering game machine 303A. FIG. 3B depicts the support structure 321A as affixed to the outer edge of the reflector element 313A. It should be noted that the position (e.g., left, right) of the light source elements 305A, 311A, 317A, and 319A is from the perspective of a player facing the wagering game machine 303A.

FIG. 3A depicts a light source element 315A as integrated into the top of the wagering game machine 303A. The light source element 315A is slightly curved across the top. FIG. 3B depicts the light source element 315A as a cylindrical light source element that runs horizontally across the top of the wagering game machine 303A.

FIG. 3B illustrates the immersive lighting structure that flanks the wagering game machine 303B as comprising light source elements 305B, 311B, 317B, and 319B, and reflective elements 307B and 313B. The light source elements 305B, 311B, and 317B and the reflective elements 307B and 313B are mounted on a pedestal 309B that supports the wagering game machine 303B. FIG. 3B depicts the light source elements 305B and 311B as circular from a top view. The light source element 305B is mounted on the pedestal 309B, at the left rear corner of the wagering game machine 303B. The light source element 311B is mounted on the pedestal 309B, at the right rear corner of the wagering game machine 303B. The reflective elements 307B and 313B are concave from a top view and an inner end of the reflective elements 307B and 313B is respectively affixed to the left and right edges of the wagering game machine 303B. The reflector elements 307B and 313B partially enclose the respective light source elements 305B and 311B. FIG. 3A depicts the light source element 305B as a cylindrical light source element that stands at a height near the height of the wagering game machine 303B. FIG. 3B depicts the light source elements 317B and 319B as semicircular from a top view. FIG. 3A depicts the light source element 317B as a cylindrical light source element that stands at a height near the height of the wagering game machine 103B. The light source element 317B is constructed within a support structure 321B that comprises a semicircular cavity to hold the light source element 317B. In FIG. 3A, the support structure 321B is mounted on the pedestal 309B, at the left edge of the wagering game machine 303B in line with the base of the wagering game machine 303B. FIG. 3B depicts the support structure 321B as affixed to the outer edge of the reflector element 307B.

FIG. 3A depicts the light source element 319B as constructed within a support structure 323B that comprises a semicircular cavity to hold the light source element 319B. FIG. 3B depicts the support structure 323B as mounted on the pedestal 309B, at the right edge of the wagering game machine 303B in line with the base of the wagering game machine 303B. The support structure 321B is affixed to the outer edge of the reflector element 313B. It should be noted that the position (e.g., left, right) of the light source elements 305B, 311B, 317B, and 319B is from the perspective of a player facing the wagering game machine 303B.

FIG. 3A depicts a light source element 315B as integrated into the top of the wagering game machine 303B. The light source element 315B is slightly curved across the top, running horizontally across the top of the wagering game machine 303B.

FIG. 3B illustrates the immersive lighting structure 301C as comprising light source elements 305C, 311C, 317C, and 319C, and reflective elements 307C and 313C. The light source elements 305C, 311C, and 317C and the reflective elements 307C and 313C are mounted on a pedestal 309C that supports the wagering game machine 303C. FIG. 3B depicts the light source elements 305C and 311C as circular from a top view. The light source element 305C is mounted on the pedestal 309C, at the left rear corner of the wagering game machine 303C. The light source element 311C is mounted on the pedestal 309C, at the right rear corner of the wagering game machine 303C. The reflective elements 307C and 313C are concave from a top view and an inner end of the reflective elements 307C and 313C is respectively affixed to the left and right edges of the wagering game machine 303C. The reflector elements 307C and 313C partially enclose the respective light source elements 305C and 311C. FIG. 3A depicts the light source element 305C as a cylindrical light source element that stands at a height near the height of the wagering game machine 303C. FIG. 3B depicts the light source elements 317C and 319C as semicircular from a top view. FIG. 3A depicts the light source element 317C as a cylindrical light source element that stands at a height near the height of the wagering game machine 103C. The light source element 317C is constructed within a support structure 321C that comprises a semicircular cavity to hold the light source element 317C. FIG. 3B depicts the support structure 321C as mounted on the pedestal 309C, at the left edge of the wagering game machine 303C in line with the base of the wagering game machine 303C. The support structure 321C is affixed to the outer edge of the reflector element 307C.

The light source element 319C is constructed within a support structure 323C that comprises a cavity to hold the light source element 319C. FIG. 3B depicts the support structure 321C as mounted on the pedestal 309C, at the right edge of the wagering game machine 303C in line with the base of the wagering game machine 303C. The support structure 321C as affixed to the outer edge of the reflector element 313C. It should be noted that the position (e.g., left, right) of the light source elements 305C, 311C, 317C, and 319C is from the perspective of a player facing the wagering game machine 303C.

FIG. 3A depicts a light source element 315C as integrated into the top of the wagering game machine 303C. The light source element 315C is slightly curved across the top, and runs horizontally across the top of the wagering game machine 303C.

The elements of the lighting structures can be arranged differently, removed, moved, adjusted, made in a variety of shapes and sizes, and made to emit or reflect various colors. In some embodiments, the light source elements 305A, 311A, 315A, 305B, 311B, 315B, 305C, 311C, and 315C may emit a first color of light. Consequently, the reflective elements 307A, 313A, 307B, 313B, 307C, and 313C may reflect the first color light as emitted by the light source elements. Meanwhile, the light source elements 317A, 319A, 317B, 319B, 317C, and 319C may emit a second color of light. In another embodiment, the light source elements 305A, 311A, 317A, 319A, 305B, 311B, 317B, 319B, 305C, 311C, 317C, and 319C may emit a steady color of light, while the light source elements 315A, 315B, and 315C may flash.

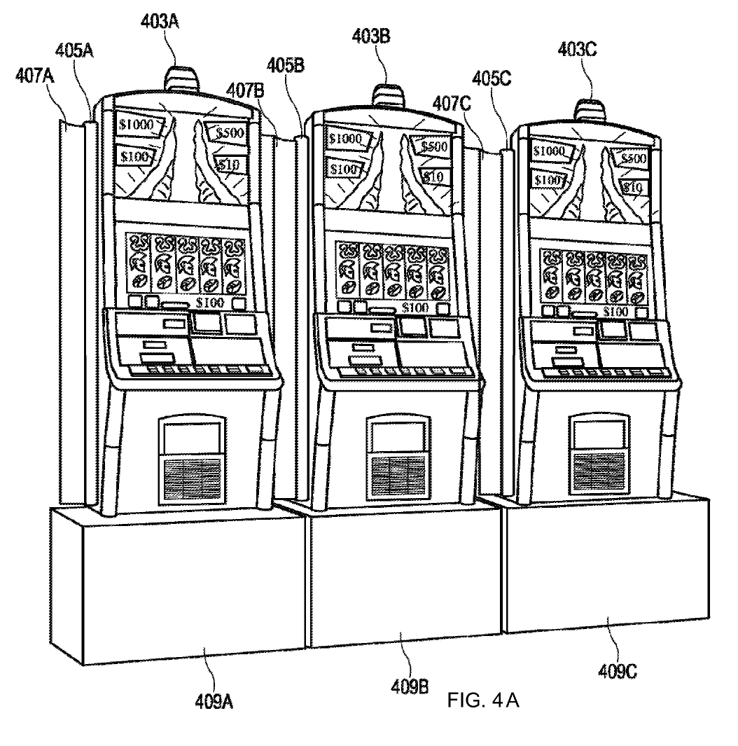

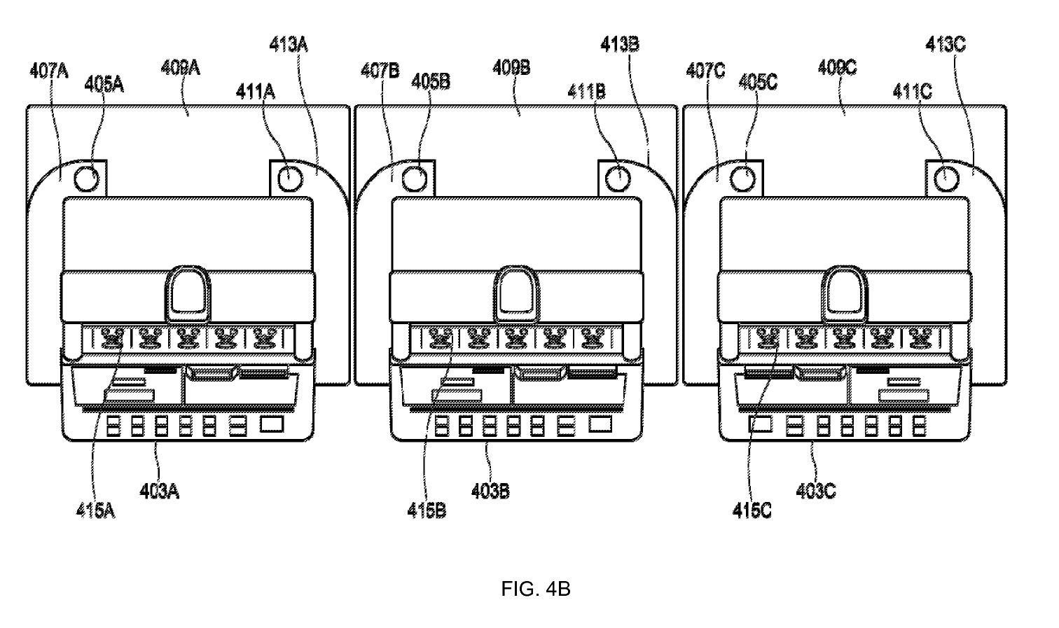

FIGS. 4A and 4B depict different views of a bank of three wagering game machines with immersive lighting structures. FIG. 4A depicts an angled front view of the bank of three wagering game machines with the immersive lighting structures according to a fourth embodiment. FIG. 4B depicts a top view of the bank of three wagering game machines with the immersive lighting structures according to a fourth embodiment. Immersive lighting structures flank wagering game machines 403A, 403B, and 403C.

FIG. 4B illustrates the elements of the immersive lighting structures. The immersive lighting structure that flanks the wagering game machine 403A comprises light source elements 405A, 411A and reflective elements 407A, 413A. The light source elements 405A, 411A are mounted on a pedestal 409A that supports the wagering game machine 403A. FIG. 4B depicts the light source elements 405A, 411A as circular from a top view. The light source element 405A is mounted on the pedestal 409A, at the left rear corner of the wagering game machine 403A, from the perspective of a player facing the wagering game machine 403A. FIG. 4A depicts the light source element 405A as a cylindrical light source element that stands at a height near the height of the wagering game machine 403A. FIG. 4B depicts the light source element 411A as mounted on the pedestal 409A at the right, rear corner of the wagering game machine 403A, from the perspective of the player facing the wagering game machine 403A. The light source element 415A is mounted on the top of the wagering game machine 403A. FIG. 4A depicts a light source element 415A as slightly curved across the top of the wagering game machine 403A. As depicted in FIG. 4B, the reflective elements 405A, 411A partially enclose the respective light source elements 405A, 411A. The reflective elements 405A, 411A are also mounted on the pedestal 409A, and affixed to the wagering game machine 403A.

The immersive lighting structure that frames the wagering game machine 403B comprises light source elements 405B, 411B and reflective elements 407B, 413B. The light source elements 405B, 411B are mounted on a pedestal 409 B that supports the wagering game machine 403B. FIG. 4B depicts the light source elements 405B, 411B as circular from a top view. The light source element 405B is mounted on the pedestal 409B, at the left rear corner of the wagering game machine 403B. The light source element 411B is mounted on the pedestal 409B at the right, rear corner of the wagering game machine 403B. It should be noted that the position (e.g., left, right) of the light source elements 405B and 411B is from the perspective of a player facing the wagering game machine 403B. A light source element 415B is integrated into the top of the wagering game machine 403B. FIG. 4A depicts the light source element 415B as slightly curved across the top of the wagering game machine 403B. As depicted in FIG. 4B, the reflective elements 405B, 411B partially enclose the respective light source elements 405B, 411B. The reflector elements 405B, 411B are also mounted on the pedestal 409B, and affixed to the wagering game machine 403B.

The immersive lighting structure that flanks the wagering game machine 403C comprises light source elements 405C, 411C and reflective elements 407C, 413C. The light source elements 40C, 411C are mounted on a pedestal 409C that supports the wagering game machine 403C. FIG. 4B depicts the light source elements 405C, 411C as circular from a top view. The light source element 405C is mounted on the pedestal 409C, at the left rear corner of the wagering game machine 403C. The light source element 411C is mounted on the pedestal 409C at the right, rear corner of the wagering game machine 403C. The position (e.g., left, right) of the light source elements 405C and 411C is from the perspective of a player facing the wagering game machine 403C. A light source element 415C is integrated into the top of the wagering game machine 403C. FIG. 4A depicts the light source element 415C as slightly curved across the top of the wagering game machine 403C. As depicted in FIG. 4B, the reflector elements 405C, 411C partially enclose the respective light source elements 405C, 411C. The reflector elements 405C, 411C are also mounted on the pedestal 409C, and affixed to the wagering game machine 403C. In embodiments, the elements of the lighting structures can be arranged differently, removable, movable, adjustable, etc. The elements can be also made in a variety of shapes and sizes. Although external to the wagering game machines 403A, 403B, 403C, the light source elements 405A, 411A, 405B, 411B, 405C, 411C can be manipulated in coordination with the light source elements 415A, 415B, 415C. In addition, the lighting structures can also comprise mechanical elements to move or adjust light source elements and/or reflective elements.

A lighting controller can be configured to control the variety of immersive lighting structures proximate to a wagering game machine (e.g., surrounding, affixed to, flanking, etc.) in accordance with game events (e.g., the wagering game being played, a bonus game, a portal game, etc.) and/or non-game events (e.g., emergency notifications, non-emergency casino announcements, etc.). The lighting controller can control the immersive lighting structure for a single wagering game machine and/or immersive lighting structures of multiple wagering game machines to produce light effects based on a lighting scheme that corresponds to a game event or non-game event. Moreover, an administrator and/or player can customize the lighting scheme, and can control/influence the light effects produced by an immersive lighting structure.

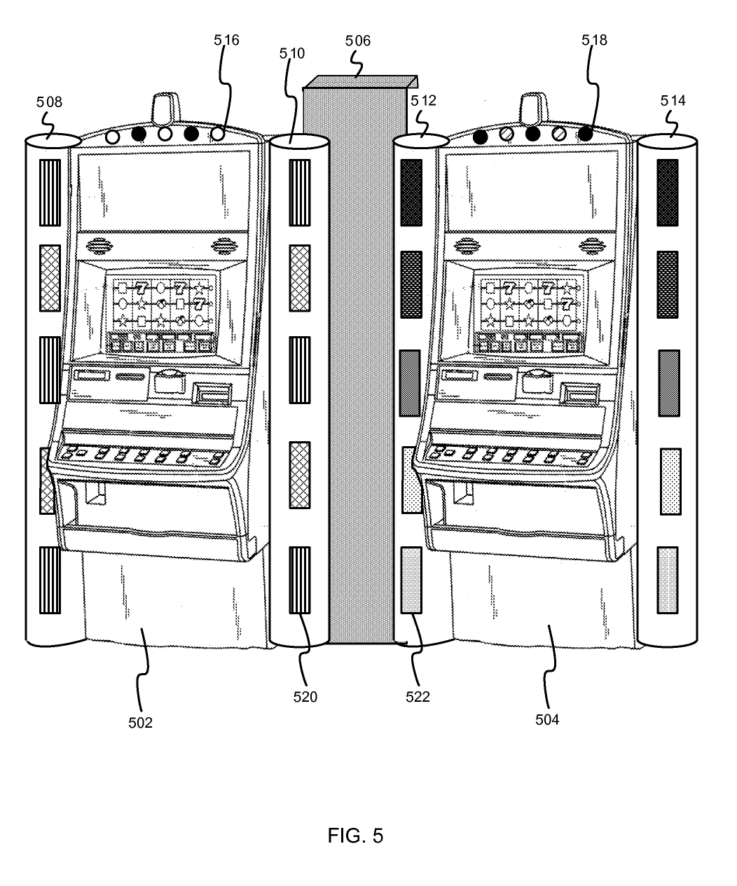

FIG. 5 illustrates wagering game machines comprising lighting influenced by game-based events on the wagering game machines. FIG. 5 depicts two wagering game machines 502 and 504. A spacer 506 provides separation between the wagering game machines 502 and 504. FIG. 5 also depicts lighting columns on both sides of the wagering game machines. The wagering game machine 502 comprises lighting columns 508 and 510 on the left and right side respectively of the wagering game machine 502. Likewise, the wagering game machine 504 comprises lighting columns 512 and 514 on the left and right side, respectively, of the wagering game machine 504. The wagering game machine 502 also comprises a panel 516 of five lights on the wagering game machine 502. Likewise, the wagering game machine 504 comprises a panel 518 of five lights on the wagering game machine 504.

In FIG. 5, each rectangular unit within the lighting columns represents a light source (e.g., light source 520 in the lighting column 510). In one implementation, the light source may comprise a set of light emitting diodes (LEDs). Examples of the LEDs include RGB LEDs, phosphor-based LEDs, organic LEDs, etc. Embodiments can utilize any suitable light source, such as light tubes, light strips, frosted light tubes, discrete compact light strips, incandescent light bulbs, etc. Particular configurations of the light source can also vary with embodiments. For instance, density of LEDs can vary from a density sufficient for low resolution displays to a high density of LEDs for high resolution display (e.g., to display animation or video). Each light source 520 may be discretely controlled. In one implementation, each light source may be controlled by a distinct set of switches and dials. In another implementation, commands for controlling the light source may specify an identification number for the light source to be controlled, an identification number for an LED within a set of LEDs to be controlled, etc. In embodiments, each light source can be a multi-colored light source or multi-color capable light source. The different colors can be determined by the type of the light source, a reflective material around the light source, colored panels, etc. In addition, light sources can shine with a different intensity, and/or be turned on or off at different instants of time. By representing light sources 520 and 522 by a different fill technique, FIG. 5 indicates that the light sources 520 and 522 emit light with different color, different intensity, different animation (e.g., twinkling lights, flickering lights, cycling through rows of lights, color transitions, light fades), etc.

The spacer 506 between the wagering game machines 502 and 504 may also be lit as depicted by shading in the spacer 506. The spacer 506 may comprise a reflective coating, which reflects light from the light source (e.g., the LED light source) to produce a soft glowing light from the spacer 506. In some implementations, a diffuser or lens may be placed in front of the light source to generate diffused lighting emanating from one or more sides of the wagering game machine 502. The degree of diffusion may also be varied.

The light source may be a direct light source or an indirect light source. For example, the LED set 520 may be a direct light source. Indirect lighting may be used to subtly light the wagering game machine 502, the areas around the wagering game machine 502, the areas between adjacent machines, etc., so as not to distract the player from the wagering game on the wagering game machine 502. Reflectors (e.g., satin reflectors) can be placed in the wagering game machines 502 and 504, can be placed proximate to the wagering game machines 502 and 504, and/or attached to the wagering game machines 502 and 504. Reflectors can also be integrated within the spacer 506 and/or integrated within the lighting columns 508, 510, 512, and 514. Reflectors can also be placed at various positions and at varying angles to create various light effects. Examples of the various light effects include subtle lighting, light shadows, contrasting light shows, etc. The light source (e.g., a light tube, a light strip, etc.) may also be coated to diffuse the light emanating from the light source. The player may customize lighting preferences to indicate the type of lighting that should be used to indicate game-based events.

The lighting structures can also comprise a set of one or more light sources such as single lights, multiple lights, an array or panel of lights, diffusers, light molds, etc. Moreover, various light patterns may be created on the wagering game machine 502 by focusing the light from the light source through patterns on the reflectors. For example, a pattern of a trophy may be projected on the wagering game machine 502 when the player wins a wagering game tournament. As another example, in case of an emergency, an arrow pattern may be created on the wagering game machines 502 and 504 to indicate an escape route.

In addition to the lighting columns 508, 510, 512, and 514, the panels of lights 516 and 518, and the spacer 506, the wagering game machines 502 and 504 may be associated with other lighting structures. For example, a light source can be mounted on top of the wagering game machine 502. A separate crown structure, with a set of lights, may also be fitted onto the wagering game machine 502. In addition to coupling lighting structures on or around the wagering game machine 502, lighting structures can at least partially be internally coupled with a wagering game machine. For example, the wagering game machine 502 may be constructed to comprise connections for the light sources, cavities, or grooves in the body of the wagering game machine 502 to house the light sources, the reflectors, etc.

Embodiments can also arrange the lighting structures to illuminate a player(s) to reflect an event(s) (e.g., game celebration, emergency procedures, etc.). For example, the colors or lighting effects may be projected onto a player and may be varied in accordance with wagering game events, the player's favorite colors, colors of the player's team, etc. In embodiments, a pedestal, the wagering game machine 502, and/or a chair at the wagering game machine 502 may detect a position of the player. For example, an armrest on the chair may comprise sensors that detect the player's arms on the armrest. As another example, the player may be linked to the wagering game machine (e.g., the player may clip a sensor to his/her clothes, wear a reflective vest, armbands, etc., connected to the wagering game machine, etc.). On detecting the player, lights/patterns can be projected onto the player.

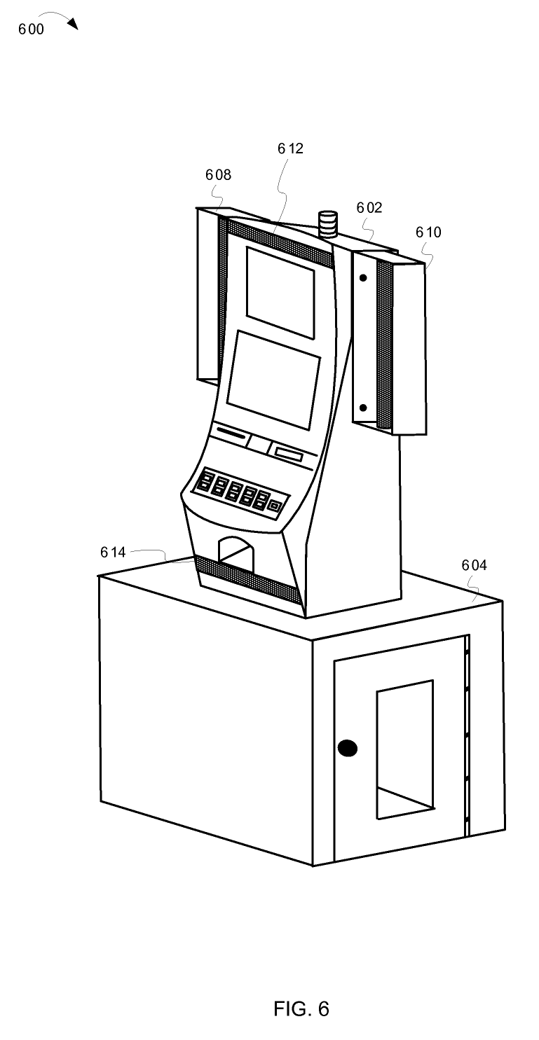

FIG. 6 illustrates another example of a wagering game machine comprising integrated lighting structures. In FIG. 6, a wagering game machine 602 is mounted on a pedestal 604. A storage unit may be integrated into the pedestal 604. In the example of FIG. 6, the inside of the pedestal 604 may be hollow and may comprise shelves and drawers for storing various components such as media servers, printers, etc. The pedestal 604 may also house light sources to provide lighting for the wagering game machine 602 and the pedestal 604. The pedestal 604 may also house a device or electronics for controlling the light sources (e.g., a lighting control board or lighting control unit) and consequently lighting of/around the wagering game machine 602.

The wagering game machine 602 comprises lighting structures integrated into the body of the wagering game machine 602. For example, lighting structures 608 and 610 are integrated into the sides of the wagering game machine 602. The lighting structures 608 and 610 comprise slots for light sources. The wagering game machine 602 also comprises lighting structures 612 and 614 integrated into the front face of the wagering game machine 602. In addition to the lighting structures on the body of the wagering game machine 602, lighting structures may also be mounted on or integrated into the pedestal 604.

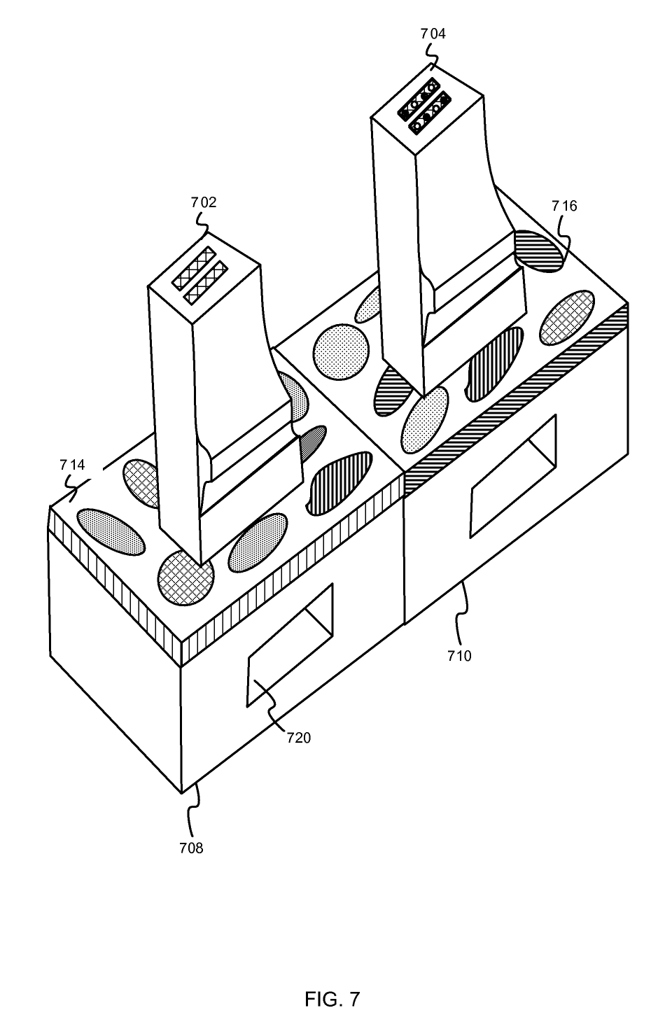

FIG. 7 depicts an example illustration of a pedestal with integrated lighting. FIG. 7 depicts two adjacent wagering game machines 702 and 704. The wagering game machine 702 is placed on a pedestal 708 while the wagering game machine 704 is placed on a pedestal 710.

Light sources may be mounted inside or on the pedestals. Wiring for the light sources may also be housed inside the pedestals 708 and 710. In addition to light sources, the pedestal 708 may also comprise reflectors, diffusers, patterns, etc. for generating a variety of light effects on/from the pedestal 708. As depicted in FIG. 7, the tops 714 and 716 of the respective pedestals 708 and 710 comprise a variety of light sources—each with different shapes, possibly emanating different colored light and with different intensity. The light effects presented on/from the pedestals 708 and 710 can be dependent on game-based/casino based events and may be controlled by the lighting control boards of the wagering game machines 702 and 704. For example, on detecting a game-based event, the lighting control board may vary lighting on the wagering game machine 702 and the pedestal 708 in accordance with a lighting scheme for a game-based event associated with the wagering game machine 702, or even a nearby wagering game machine.

The pedestals may also comprise a footrest (e.g., footrest 720 in the pedestal 708) for players to place their feet while playing a wagering game on the wagering game machine. In one implementation, the footrest 720 may comprise a sensor (e.g., a pressure sensor) that activates the lighting on the pedestal 708 when a player places his/her feet on the footrest.

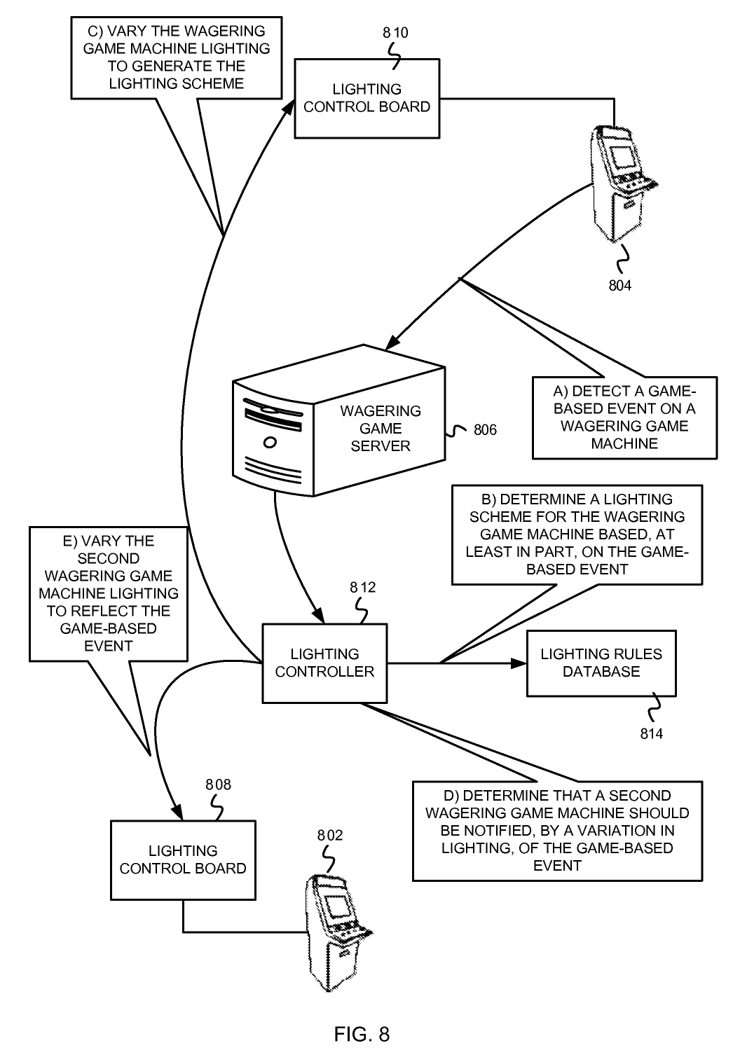

Each of the wagering game machines 702 and 704 may comprise lighting control boards that can control the lighting on the wagering game machines 702 and 704 and their respective pedestals 708 and 710. A lighting controller may control/instruct each of the lighting control boards as indicated in FIG. 8.

FIG. 8 is a conceptual diagram illustrating game-based control of wagering game machine lighting. FIG. 8 depicts wagering game machines 802 and 804. The wagering game machine 802 is coupled with a lighting control board 808. The wagering game machine 804 is coupled with a lighting control board 810. In embodiments, a wagering game machine may house the control board, the control board can be plugged into a backplane, can be coupled via an external port, etc. The lighting control boards 808 and 810 control lighting associated the wagering game machines 802 and 804 (e.g., proximate, attached, etc.) respectively to indicate game-based events. The lighting control boards 808 and 810 communicate with the lighting controller 812. The lighting controller 812 is communicatively coupled with a wagering game server 806 and a lighting rules database 814. The wagering game machines 802 and 804 also communicate with the wagering game server 806.

At stage A, the wagering game server 806 detects a game-based event on the wagering game machine 804. In one implementation, the wagering game machine 804 communicates the game-based event to the wagering game server 806. For example, the wagering game machine 804 may notify the wagering game server 806 in response to a player wagering, winning, losing, qualifying for an award, progressing in a game, etc. As another example, the wagering game machine 804 can notify the wagering game server 806 if the player gets a specific game result, such as a “royal flush” while playing a poker game on the wagering game machine 804. In another implementation, the wagering game server 806 may monitor the player's activities on the wagering game machine 804 to identify the game-based event. For example, the wagering game server 806 may monitor the player's activities and generate the game-based event on detecting that the player has hit a particular symbol sequence.

At stage B, the lighting controller 812 determines a lighting scheme for the wagering game machine 804 based, at least in part, on the game-based event. The wagering game server 806 may communicate the game-based event to the lighting controller 812. In some implementations, the lighting controller 812 receives notifications of the game-based event from the wagering game machine 804 or the wagering game server 806. In other implementations, the lighting controller 812 monitors player activities on and operations of the wagering game machine 804 to identify the game-based event. The lighting controller 812 directs the lighting control board 810 to vary the lighting associated with the wagering game machine 804 in accordance with the game-based event. The lighting controller 812 may consult the lighting rules database 814 to determine a lighting scheme for the wagering game machine 804 based on the game-based event. For example, the lighting controller 812 may access the lighting rules database 814 and determine that for the game-based event where the player wins $100, red and blue lights in columns on both sides of the wagering game machine 804 (as depicted in FIG. 5) should successively light up for 10 seconds. The lighting controller 812 may also access a player account server (not shown) to determine whether the player has configured lighting preferences. For example, the player may configure the lighting preferences so that the wagering game machine 804 displays subtle lighting variations on detecting the game-based event. As another example, the player may configure the lighting preferences so that the lighting structures associated with the wagering game machine 804 always shine with a high intensity, blink, and present animation to indicate the game-based event until a next game-based event is detected or until the player logs off the wagering game machine 804.

At stage C, the lighting controller 812 directs the lighting control board 810 to vary the lighting of the wagering game machine 804 in accordance with the lighting scheme (determined at stage B). Alternately, the lighting controller 812 can explicitly control timing and light effects across the wagering game machines 802 and 804, proximate lighting structures (e.g., lighting of columns 508, 510, 512, and 514 of FIG. 5, spacer 506, etc.), lighting in the pedestals 708 and 710 of FIG. 7, etc. The lighting controller 814 can direct the lighting control board 810 to switch on/off light sources associated with the wagering game machine 804, vary intensity of the light sources, generate light animation and movement, modify gradient of light, etc. The lighting control board 810 can vary the lights associated with the wagering game machine 804 in accordance with instructions from the lighting controller 812 to generate various light effects indicated by the lighting scheme for the game-based event. Some examples of the light effects include blinking lights, lights changing colors, lights fading in/fading out, creating designs/patterns using lights, flashing lights, etc. The lighting control board 810 may also control a timing with which the light sources turn on or turn off to generate light movement on the wagering game machine 804, generate light movement across wagering game machines 802 and 804, etc.

At stage D, the lighting controller 812 determines that lighting associated with the wagering game machine 802 should be varied to indicate the game-based event detected at stage A. For example, the player at the wagering game machine 804 may indicate (e.g., as part of player preferences) that the game-based event should be communicated to a set of friends. The player at the wagering game machine 804 may identify the set of friends by specifying player names, player account numbers, etc. Embodiments can also determine targets (e.g., friends, travel mates, nearby player, competitors, etc.) from player accounts, data mining, etc. In one implementation, on detecting the game-based event, the lighting controller 812 may direct the wagering game server 806 to determine (if possible) wagering game machine identifiers of the specified set of friends. The wagering game server 806 may determine the player account number of a friend of the player at the wagering game machine 804, determine that the friend has logged on to the wagering game machine 802, and communicate a device identifier for the wagering game machine 802 to the lighting controller 812. Embodiments can coordinate lighting effects of the lighting at wagering game machines for competitive games, tandem games, etc.

At stage E, the lighting controller 812 directs the lighting control board 808 to vary the lighting associated with the wagering game machine 802 to indicate the game-based event. In one implementation, the lighting controller 812 may direct the lighting control board 808 to vary the lighting associated with the wagering game machine 802 in accordance with the lighting scheme determined at stage B. In another implementation, the lighting controller 812 may determine lighting preferences configured by the player at the wagering game machine 802 and direct the lighting control board 808 to vary the lighting on the wagering game machine 802 in accordance with the player's lighting preferences. In another implementation, the lighting controller 812 may direct the lighting control board 808 to vary the lighting associated with the wagering game machine 802 in accordance with a lighting scheme for the game-based event, a lighting scheme associated with the game, a lighting scheme designated by a game developer, etc.

It should be noted that in some implementations, the lighting control boards 810 and 808 might be embodied within the lighting controller 812. For example, the lighting control boards 808 and 810 and the lighting controller 812 may be implemented on a common integrated circuit or other electronic module. As another example, a common lighting control board comprising software/firmware tailored to each wagering game machine may be implemented to control lighting on each of the wagering game machines. In other implementations, the lighting controller 812 may control lighting on the wagering game machines 802 and 804 without the intermediary lighting control boards 808 and 810 respectively. Also, in some implementations, the lighting rules database 814 may be a part of the lighting controller 812. Also, in some implementations, a single lighting control board 808 may control lighting in the wagering game machine 802, a pedestal on which the wagering game machine is mounted (e.g., the pedestal 708 of FIG. 7), other wagering game machine structures (e.g., spacers, columns, etc.), and illumination of the player playing the wagering game. In other implementations, separate lighting control boards may control the lighting in the wagering game machine 802, the pedestal on which the wagering game machine is mounted, and the other wagering game machine constructs.

### Example Operations

This section describes operations associated with some embodiments of the invention. In the discussion below, the flow diagrams will be described with reference to the block diagrams presented above. However, in some embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

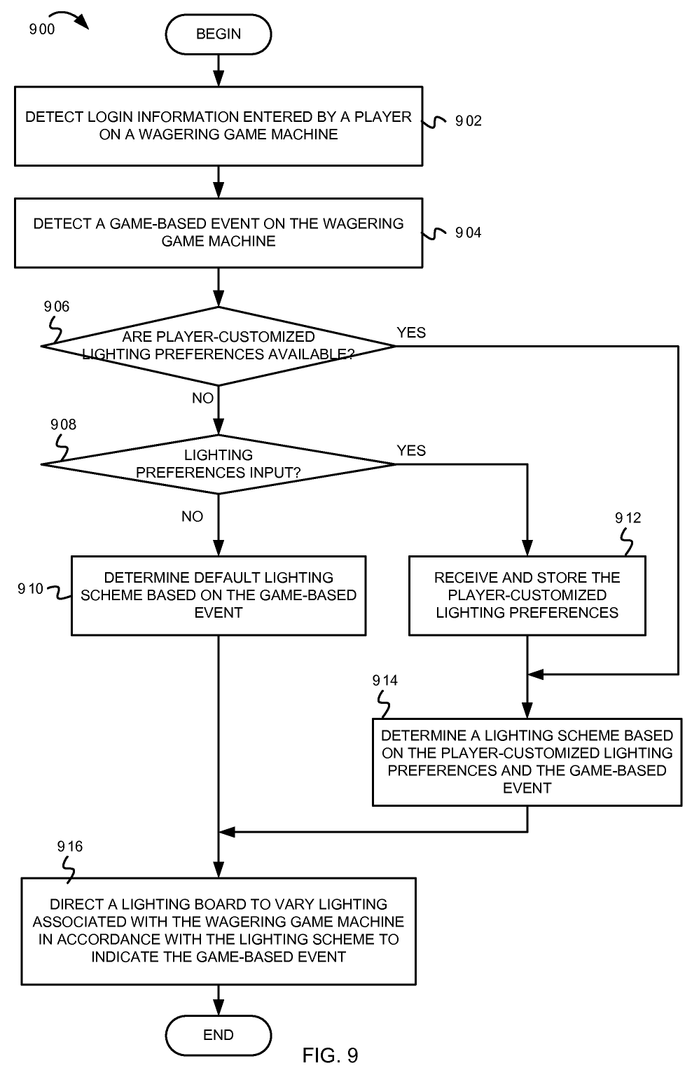

FIG. 9 is a flow diagram illustrating example operations for controlling wagering game machine lighting in accordance with game-based events. Flow 900 begins at block 902.

At block 902, login information entered by a player (“player login information”) on the wagering game machine is detected. In one implementation, the wagering game server 806 of FIG. 8 may receive the player login information in response to the player logging onto the wagering game machine 802. For example, the player may log onto the wagering game machine using a player identification card, entering a password on a keypad, biometric scanning (e.g., fingerprint scan), providing a writing sample for handwriting verification, speaking a pre-defined set of words for voice recognition, etc. The wagering game server 806 can capture the player login information (e.g., voice characteristics, biometric data, player card information, etc.) and validate the player login information. After the player login information is validated, the flow continues at block 904.

At block 904, a game-based event is detected on the wagering game machine. The game-based event may be an event encountered as a result of the player achieving specified criteria associated with a wagering game on the wagering game machine. For example, the game-based event may be generated in response to the player wagering, spending, winning, or losing a threshold amount of money, qualifying for a bonus game, etc. As another example, the game-based event may be generated if the player logs on to a specified wagering game machine. As another example, the game-based event may be generated if the player gets a specific game result, such as a “full house” while playing a poker game on the wagering game machine. In one implementation, the wagering game machine may generate the game-based event and communicate the game-based event to a wagering game server, a lighting controller, etc. In another implementation, the wagering game server may monitor player activities on the wagering game machine and operations of the wagering game machine and detect the game-based event. The flow continues at block 906.

At block 906, it is determined whether player-customized lighting preferences are available. The player may indicate lighting preferences so that the lighting on the wagering game machine is varied in accordance with the lighting preferences. The player login information (e.g., voice characteristics, biometric data, player card information, etc.), retrieved when the player logs onto the wagering game machine, may be used to access the player's account to determine whether the player has configured the lighting preferences. If it is determined that the player-customized lighting preferences are available, the flow continues at block 914. Otherwise, the flow continues at block 908.

At block 908, it is determined if lighting preferences are input. On determining that the player-customized lighting preferences are not available, the wagering game machine may present a prompt giving the player an option to customize the lighting preferences. The player can customize the lighting preferences by filling out a questionnaire on the wagering game machine. For example, the player may indicate that the lighting on the wagering game machine should be subtle without dramatic flashes of light or machine-to-machine light movement. As another example, the player may indicate that the lighting on the wagering game machine should comprise dramatic flashes of lights, variation in light colors, and a variation of lighting on adjacent wagering game machines to indicate a celebratory game-based event (e.g., a jackpot). As another example, the player may not want the wagering game machine to vary the lighting for every game-based event and may, therefore, disable game-based lighting on the wagering game machine. The wagering game machine may prompt the player to indicate any preferences in colors (e.g., the player may not like or be able to perceive certain colors). Alternately, the player may choose not to customize the lighting preferences.

In some implementations, the player may customize the lighting preferences by selecting from a choice of “bold lighting”, “subtle lighting”, and “disable lighting”. The lighting on the wagering game machine may be varied according to a pre-defined lighting scheme for the game-based event based on the player's selection. In other implementations, a player may configure detailed lighting preferences. The player may indicate different lighting preferences for each wagering game, select desired lighting effects to indicate game-based events for each of the wagering games, etc. For example, the player may configure different lighting preferences for different winning hands (e.g., a royal flush, a full house, etc.) in a poker wagering game. In some implementations, the player may also customize a time interval for which the game-based event is indicated in the lighting on the wagering game machine. For example, player may indicate that a game-based event should be indicated in the wagering game machine lighting until a next game-based event is detected. If it is determined that the lighting preferences are input, the flow continues at block 910. Otherwise, the flow continues at block 912.

At block 912, the player-customized lighting preferences are received and stored. The player-customized lighting preferences may be associated with the player's account and may be stored in a player account server. The flow continues at block 914.

At block 914, a lighting scheme is determined based on the player-customized lighting preferences and the game-based event. In one implementation, a lighting rules database (e.g., the lighting rules database 814 of FIG. 8) may store different variations of the lighting scheme for the game-based event and the appropriate lighting scheme may be selected based on the lighting preferences. For example, a lighting scheme comprising bold flashes of light and inter-machine light movements may be selected in response to detecting a “jackpot” game event and the player's preference for a bold lighting scheme. As another example, a lighting scheme with diffused lighting and gradual color variations may be selected in response to detecting the “jackpot” game event and the player's preference for a subtle lighting scheme. In other implementations, a player-customized lighting scheme configured specifically to indicate the game-based event might be identified. After the lighting scheme, based on the player-customized lighting preferences and the game-based event, is determined, the flow continues at block 916.

At block 916, a lighting control board associated with the wagering game machine is directed to vary lighting associated with the wagering game machine, in accordance with the lighting scheme, to indicate the game-based event. In accordance with the lighting scheme, the lighting proximate to the wagering game machine may be varied to indicate a player winning or losing a wagering game, the player waiting for a game result (i.e. an anticipatory game-based event), the player winning a wagering game tournament, etc. For example, red lights on the wagering game machine may blink when the player loses the wagering game. As another example, green and yellow light movement around the wagering game machine may be displayed if the player wins the wagering game. As another example, the lighting on the wagering game machine may be varied based on a payback percentage from the wagering game machine. The light intensity and the degree of diffusion may be varied as a direct function of the payback percentage. Low intensity lighting may be displayed on the wagering game machine if an amount won is 20% of a wagered amount. On the other hand, high intensity lighting may be displayed if the player wins 100% of the wagered amount. The lighting control board may turn on/off light sources on the wagering game machine, vary a degree of diffusion of light diffusers, vary intensity of the light sources, generate light patterns by focusing light through patterns in reflectors, create light movement on the wagering game machine, create inter-wagering game machine light movement, and other such light effects. From block 916, the flow ends.

At block 910, a default lighting scheme is determined based on the game-based event. The flow 900 moves from block 908 to block 910 if it is determined that the player-customized lighting preferences are not available and that the player does not wish to customize the lighting preferences. The default lighting scheme for the wagering game machine may be retrieved from the lighting rules database. The default lighting scheme may not reflect the player's lighting preferences and may comprise a combination of direct lighting and indirect lighting on the wagering game machine. After the default lighting scheme indicating the game-based event is determined, the flow continues at block 916. The flow ends after the lighting board associated with the wagering game machine varies the lighting on the wagering game machine to reflect the default lighting scheme indicating the game-based event. Additional operations may be performed to determine a configuration of an immersive lighting structure to influence or inform selection of a lighting scheme. For instance, particular immersive lighting structure configurations may be more suitable for a particular lighting scheme. A lighting scheme may require a certain number of lighting source elements and rely on reflectors arranged in a particular manner. For example, operations can determine an identity of a wagering game machine (e.g., network address, serial number, etc.), and then look-up one or more immersive lighting structure configurations or arrangements associated with the wagering game machine (e.g., due to proximity) in a database or a mark-up file for the wagering game machine.

It should be noted that although FIG. 9 depicts prompting a player to customize the lighting preferences after the game-based event is detected, in some implementations, the player might be prompted to customize the lighting preferences soon after the player logs on to the wagering game machine. In some implementations, after detecting the game-based event, if lighting preferences and/or a player-customized lighting scheme cannot be determined, the default lighting scheme may be utilized to vary the lighting of the wagering game machine following which the player may be prompted to customize the lighting preferences.

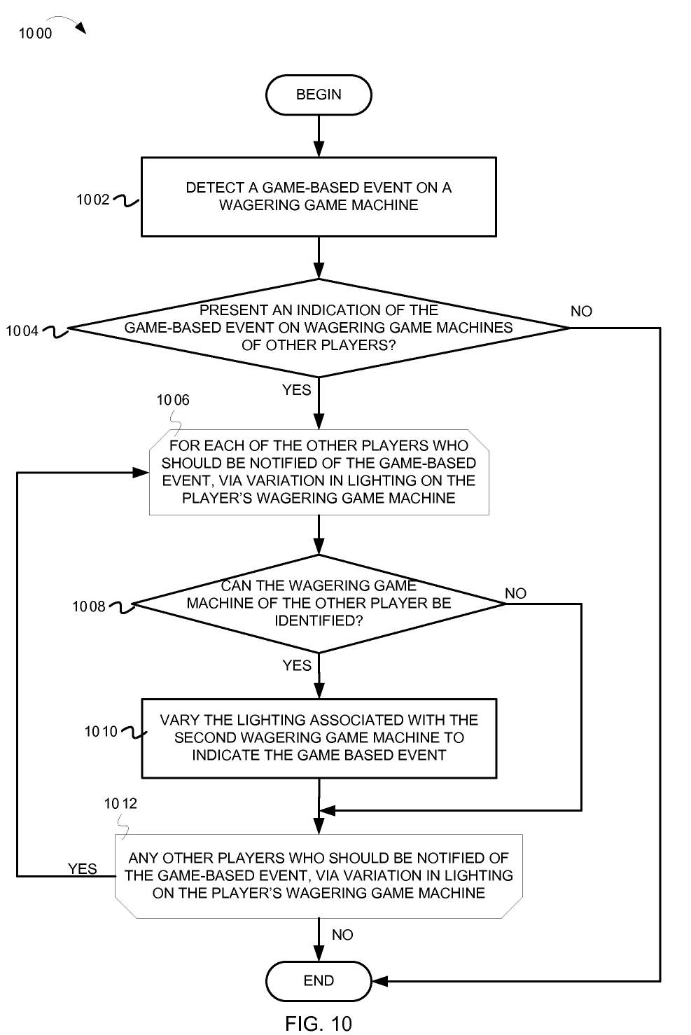

As already described, a lighting scheme can involve controlling lighting across multiple wagering game machines. FIG. 10 is a flow diagram illustrating example operations for synchronizing lighting across multiple wagering game machines. Flow 1000 begins at block 1002.

At block 1002, an event is detected on a wagering game machine. As an example, the event may be generated in response to the player wagering, performing non-gaming operations (e.g., purchasing show tickets at the wagering game machine), winning, or losing an amount of money/credits. As another example, the game-based event may be generated if the player gets a specific game result such as a accessing a particular game stage of a persistent state wagering game. The flow continues at block 1004.

At block 1004, it is determined whether an indication of the game-based event should be presented on wagering game machines of one or more other players. For example, it may be determined whether lighting on the first wagering game machine should be synchronized with lighting on other wagering game machines associated with the one or more other players, located nearby, and/or associated with the wagering game being played. Lighting preferences of the player at the first wagering game machine may be accessed to determine whether the game-based event should be indicated, via lighting, on the other wagering game machines. The lighting preferences may indicate that game-based event should be shared with friends of the player at the first wagering game machine by varying the lighting of wagering game machines on which the friends are playing wagering games. The lighting preferences may also indicate names, player account numbers, etc. of the friends who are to be notified of the game-based event. The lighting of any suitable number of wagering game machines may be synchronized. For example, the lighting preferences of the player at the first wagering game machine may indicate a list of ten friends that should be notified of the game-based event, via variations in lighting on the friends' wagering game machines. As another example, the lighting configuration of a casino) may indicate that lighting of all wagering game machines in the casino should be varied to indicate the game-based event. As another example, the lighting preferences of the player at the first wagering game machine (or the lighting configuration of the casino) may indicate that lighting of wagering game machines within a 100 ft radius of the first wagering game machine should be varied to indicate the game-based event. If it is determined that the indication of the game-based event should be presented on wagering game machines of one or more other players, the flow continues at block 1006. Otherwise, the flow ends.

At block 1006, a loop is begun to perform a set of operations (described in blocks 1008 and 1010) on the wagering game machines of each of the other players. The operations comprise indicating the game-based event by controlling lighting on the wagering game machines of the other players. At block 1006, it is determined whether there exists another player who should be notified of the game-based event, via variation in lighting on the player's wagering game machine. If one exists, the player to be notified is identified. Flow continues at block 1008.

At block 1008, it is determined whether the wagering game machine of the other player can be identified. For example, it may be determined whether the friend to be notified of the game-based event has logged onto the wagering game machine. A wagering game server may access player account information and search through a list of players currently playing wagering games on wagering game machines to determine whether the other player to be notified of the game-based event has logged onto a wagering game machine. On determining that the other player, to be notified of the game-based event, has logged onto a wagering game machine, a device identifier of the wagering game machine may be identified and transmitted to a lighting controller. As another example, a machine associated with a lighting controller can determine the wagering game machines within a same bank as the wagering game machine that corresponds to the event. If it is determined that the wagering game machine of the other player can be identified, the flow continues at block 1010. Otherwise, the flow continues at block 1012.

At block 1010, lighting associated with the wagering game machine of the other player is varied to indicate the game-based event. Additionally, lighting of a pedestal on which the wagering game machine is mounted and/or lighting of other constructs (e.g., a spacer between adjacent wagering game machines, columns on both sides of the wagering game machine, etc.) of the wagering game machine may also be varied. In one implementation, a lighting scheme used to indicate the game-based event on the first wagering game machine might be mirrored on the wagering game machine of the other player. In another implementation, the lighting on the wagering game machine of the other player may be varied based on a lighting scheme determined in accordance with lighting preferences customized by the other player. The flow continues at block 1012.

At block 1012, the loop for each of the players who should be notified of the game-based event, via variation in lighting on the player's wagering game machine ends. If there are additional players, then control flows back to block 1006, where the next player is identified and the operations described with reference to block 1008 and 1010 are performed for the next player. The loop ends when it is determined that the loop operations (block 1008 and block 1010) have been performed for every player who should be notified of the game-based event, via variation in lighting on the player's wagering game machine.

Although the example depicted by FIG. 10 involves looping through other wagering game machines, embodiments are not so limited. Embodiments can determine a group of wagering game machines subject to a lighting scheme. After determining the group of wagering game machines, a lighting controller can apply a lighting scheme (e.g., transmit instructions, execute commands or scripts, etc.) to the group of wagering game machines. Embodiments can also synchronize lighting effects between groups of wagering game machines, as well as individual wagering game machines.

In addition, the example depicted in FIG. 10 illustrates synchronized lighting on wagering game machines with players, embodiments are not so limited. Embodiments can coordinate lighting effects across wagering game machines that are not being played. For example, a lighting controller can determine a lighting scheme for an emergency event. The lighting controller determines that the lighting scheme involves controlling lighting effects across wagering game machines that satisfy different criteria. The lighting controller can determine a first lighting effect to be applied to wagering game machines that do not have players (“idle WGMs”), and a second lighting effect to be applied to wagering game machines that have players (“in-play WGMs”). The lighting controller also determines that the different lighting effects are to be synchronized to avoid interference. For instance, the lighting controller can control the lighting structures of in-play WGMs to convey an emergency message or direct people's attention to an emergency message being displayed overhead. The lighting controller can cause the first lighting effect to pause, and then cause the second lighting effect to draw the attention of people walking through a casino to inform them of an emergency situation. Although the example referred to idle and in-play, criteria can be defined based on any one of state (e.g., active, in-service, idle, etc.) and attributes (e.g., hardware, location, manufacturer, etc.).

### Operating Environment

This section describes an example operating environment and presents structural aspects of some embodiments. This section includes discussion about wagering game machine networks and wagering game architectures.

### Wagering Game Networks

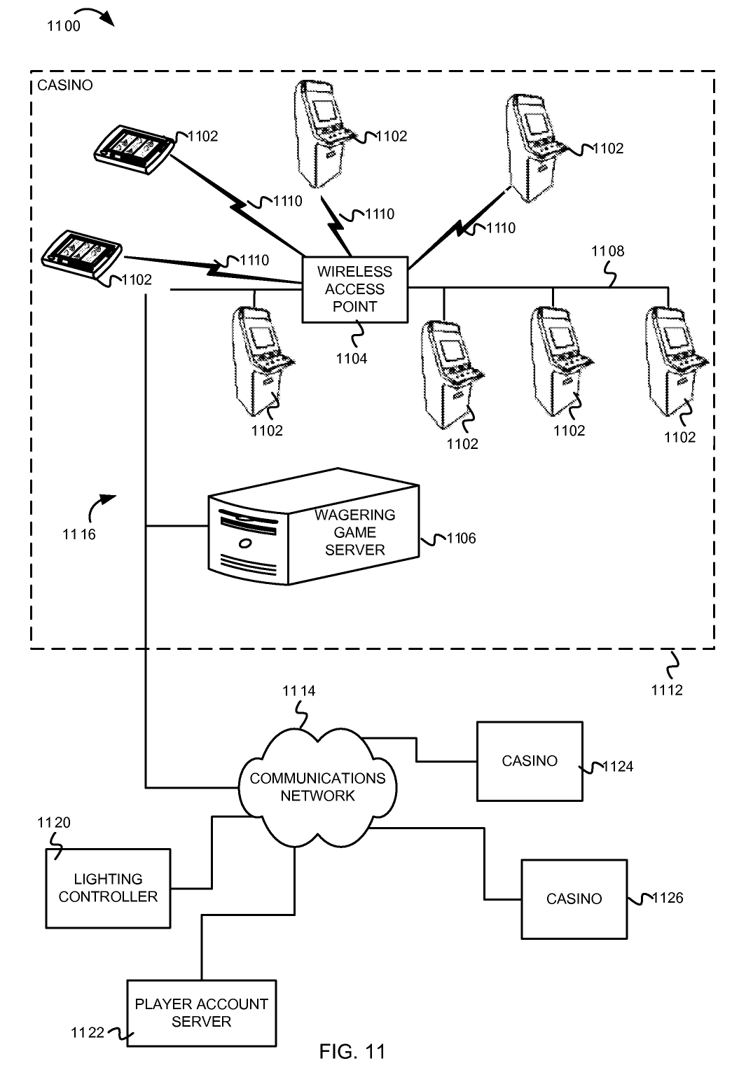

FIG. 11 is a block diagram illustrating a wagering game network 1100, according to example embodiments of the invention. As shown in FIG. 11, the wagering game network 1100 includes a plurality of casinos 1112, 1124, and 1126 connected to a communications network 1114. The plurality of casinos is also connected to a player account server 1122 and a lighting controller 1120 via the communications network 1114.

Each casino 1112 includes a local area network 1116, which includes an access point 1104, a wagering game server 1106, and wagering game machines 1102. The access point 1104 provides wireless communication links 1110 and wired communication links 1108. The wired and wireless communication links can employ any suitable connection technology, such as Bluetooth, 802.11, Ethernet, public switched telephone networks, SONET, etc. In some embodiments, the wagering game server 1106 can serve wagering games and distribute content to devices located in other casinos 1112 or at other locations on the communications network 1114.

The player account server 1122 stores player information identifying the player, such as biometric information, player name and identification number, voice characteristics (e.g., for voice recognition), handwriting characteristics (e.g., for signature recognition), etc. The player account server 1122 may also comprise player-customized lighting preferences and/or a player-customized lighting scheme for controlling the lighting on the wagering game machine 1102 to indicate a game-based event. The player account server 1122 may also indicate whether other players should be notified of the game-based event. For example, a player may specify player account numbers of friends that should be notified of the game-based event. On detecting the game-based event, the wagering game server 1106 may use the player account numbers to determine whether the player's friends have logged onto wagering game machines. The wagering game server 1106 may determine device identifiers of the wagering game machines onto which the player's friends have logged on, and communicate the device identifiers to the lighting controller 1120.

The lighting controller 1120 controls lighting on the wagering game machines 1102 based in part on game-based events. The lighting controller 1120 can determine the lighting scheme for one or more of the wagering game machines 1102 based on the game-based events detected on the one or more of the wagering game machines 1102. The lighting controller 1120 may determine how often lights on the wagering game machine 1102 should be turned on/off, a light intensity, a degree of transparency for light diffusers, an angle at which the light from light sources should reflect off the reflectors, etc. in order to generate light effects that indicate the game-based event. Additionally, the lighting scheme may also be determined based on the player-customized lighting preferences. The lighting controller 1120 may also determine a lighting scheme for notifying the player's friends of the player's game-based event. The lighting controller 1120 may mirror the lighting scheme, select a new lighting scheme based on the friend's lighting preferences, or access a default lighting scheme to notify the player's friends (via lighting on their wagering game machines) of the game-based event.

The wagering game machines 1102 described herein can take any suitable form, such as floor standing models, bartop models, workstation-type console models, etc. In one embodiment, the wagering game network 1100 can include other network devices, such as accounting servers, wide area progressive servers, player tracking servers, and/or other devices suitable for use in connection with embodiments of the invention.

In some embodiments, wagering game machines 1102 and wagering game servers 1106 work together such that a wagering game machine 1102 can be operated as a thin, thick, or intermediate client. For example, one or more elements of game play may be controlled by the wagering game machine 1102 (client) or the wagering game server 1106 (server). Game play elements can include executable game code, lookup tables, configuration files, game outcome, audio or visual representations of the game, game assets, or the like. In a thin-client example, the wagering game server 1106 can perform functions such as determining game outcome or managing assets, while the wagering game machine 1102 can present a graphical representation of such outcome or asset modification to the user (e.g., player). In a thick-client example, the wagering game machines 1102 can determine game outcomes and communicate the outcomes to the wagering game server 1106 for recording or managing a player's account.

In some embodiments, either the wagering game machines 1102 (client) or the wagering game server 1106 can provide functionality that is not directly related to game play. For example, account transactions and account rules may be managed centrally (e.g., by the wagering game server 1106) or locally (e.g., by the wagering game machine 1102). Other functionality not directly related to game play may include power management, presentation of advertising, software or firmware updates, system quality or security checks, etc.

Any of the wagering game network components (e.g., the wagering game machines 1102) can include hardware and machine-readable media including instructions for performing the operations described herein. The following section describes architecture of the wagering game machine.

### Wagering Game Machine Architectures

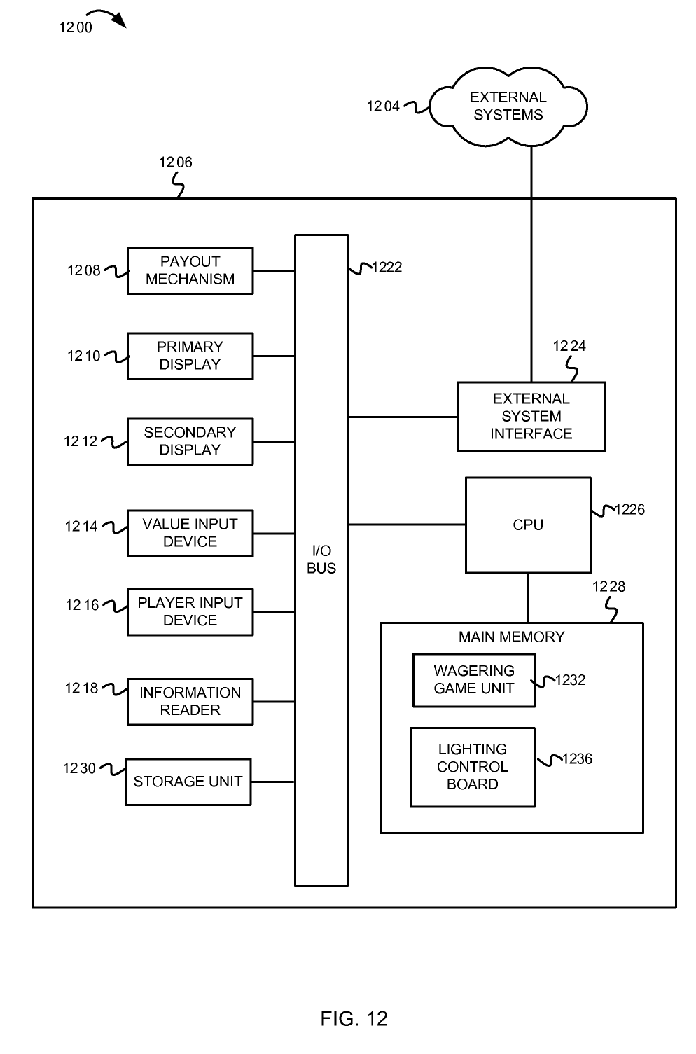

FIG. 12 is a block diagram illustrating wagering game machine architecture, according to example embodiments of the invention. As shown in FIG. 12, the wagering game machine architecture 1200 includes a wagering game machine 1206, which includes a central processing unit (CPU) 1226 connected to main memory 1228. The CPU 1226 can include any suitable processor, such as an Intel® Pentium processor, Intel® Core 2 Duo processor, AMD Opteron™ processor, or U1traSPARC processor. The main memory 1228 comprises a wagering game unit 1232 and a lighting controller 1240. In one embodiment, the wagering game unit 1232 can present wagering games, such as video poker, video black jack, video slots, video lottery, etc., in whole or part. The lighting controller 1240 can determine lighting schemes, determine/generate lighting instructions, determine lighting preferences based on player accounts and/or casino parameters, etc. Embodiments are not limited to implementing functionality of a lighting controller within a wagering game machine or separate from a wagering game machine (e.g., in a backend server). Functionality of a lighting controller can also be divided to varying degrees between the wagering game machine and a separate device. For instance, the wagering game machine can determine a lighting scheme based on a gaming event and generate lighting instructions, while a separate machine determines lighting preferences from a player account and casino parameters for possibly modifying the lighting scheme.

The wagering game machine 1206 also includes a lighting control board 1236. The lighting control board 1236 implements functionality to control lighting on the wagering game machine 1206 in accordance with game-based events generated on the wagering game machine and/or player-customized lighting preferences. The lighting control board 1236 operates in accordance with instructions from the lighting controller 1240.

The CPU 1226 is also connected to an input/output (I/O) bus 1222, which can include any suitable bus technologies, such as an AGTL+ frontside bus and a PCI backside bus. The I/O bus 1222 is connected to a payout mechanism 1208, primary display 1210, secondary display 1212, value input device 1214, player input device 1216, information reader 1218, and storage unit 1230. The player input device 1216 can include the value input device 1214 to the extent the player input device 1216 is used to place wagers. The I/O bus 1222 is also connected to an external system interface 1224, which is connected to external systems 1204 (e.g., wagering game networks).

In one embodiment, the wagering game machine 1206 can include additional peripheral devices and/or more than one of each component shown in FIG. 12. For example, in one embodiment, the wagering game machine 1206 can include multiple external system interfaces 1224 and/or multiple CPUs 1226. In one embodiment, any of the components can be integrated or subdivided.

Any component of the architecture 1200 can include hardware, firmware, and/or machine-readable media including instructions for performing the operations described herein. Machine-readable media includes any mechanism that provides (i.e., stores and/or transmits) information in a form readable by a machine (e.g., a wagering game machine, computer, etc.). Examples of machine-readable storage media include read only memory (ROM), random access memory (RAM), magnetic disk storage media, optical storage media, flash memory machines, etc. Machine-readable media can also be a machine-readable transmission media suitable for transmitting software over a network.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method of controlling an immersive lighting structure proximate to a wagering game machine but external to the wagering game machine, the method comprising:
receiving an indication of a wagering game-based event communicated over a network and that corresponds to the wagering game machine;
determining a configuration of the immersive lighting structure proximate to the wagering game machine;
determining a lighting scheme for the wagering game-based event and based, at least in part, on the configuration of the immersive lighting structure; and
directing a lighting control unit to control, in accordance with the lighting scheme for the wagering game-based event, the immersive lighting structure.

2. The method of claim 1, further comprising detecting the wagering game-based event on the wagering game machine in response to detecting an achievement of specified criteria associated with a wagering game on the wagering game machine.

3. The method of claim 1, further comprising:
identifying a second wagering game machine at which the wagering game-based event should be indicated; and
directing the lighting control unit to control a second immersive lighting structure proximate to a second wagering game machine.

4. The method of claim 3, wherein the second immersive lighting structure is controlled in accordance with at least one of the lighting scheme for the wagering game-based event and a second lighting scheme customization indicated in a player account associated with the second wagering game machine.

5. The method of claim 1, further comprising:
determining, for a second wagering game-based event, a second lighting scheme based, at least in part, on player preference data indicated in an account currently associated with the first wagering game machine and on the configuration of the immersive lighting structure; and
directing the lighting control unit to control, in accordance with the second lighting scheme, the immersive lighting structure at the wagering game machine.

6. The method of claim 5, further comprising modifying a default lighting scheme in accordance with the player preference data to generate the second lighting scheme.

7. The method of claim 1, wherein the immersive lighting structure comprises at least one of a light source element, an array of light source elements, a light source element masked by one of a diffuser, a lens, and a reflector, and a reflector element.

8. The method of claim 1, wherein the directing the lighting control unit comprises directing the lighting control unit to present at least one of dramatic flashes by the immersive lighting structure, light movement between the immersive lighting structure at the wagering game machine and a second immersive lighting structure at a second wagering game machine, a variation of colors and intensity by the immersive lighting structure, and animation by the immersive lighting structure.

9. The method of claim 1, further comprising directing the lighting control unit to control, in accordance with the lighting scheme for the wagering game-based event, a lighting structure integrated with a pedestal that supports the wagering game machine.

10. The method of claim 9 further comprising a footrest of the pedestal detecting a player at the wagering game machine and triggering the lighting structure in response thereto.

11. A method of controlling a plurality of immersive lighting structures proximate to a plurality of wagering game machines but external to the plurality of wagering game machines, the method comprising:
determining an arrangement of the plurality of immersive lighting structures in response to receiving an indication of a wagering game-based event communicated over a network from a first wagering game machine of the plurality of wagering game machines
determining a lighting scheme based, at least in part on the wagering game-based event and the arrangement of the plurality of immersive lighting structures; and
directing a lighting control unit to control, in accordance with the lighting scheme the plurality of immersive lighting structures.

12. The method of claim 11 further comprising determining that a second wagering game machine of the plurality of wagering game machines is proximate to the first wagering game machine.

13. The method of claim 12 further comprising:
determining that a first player account currently associated with the first wagering game machine indicates a second player account; and
identifying the second wagering game machine as currently associated with the second player account.

14. An apparatus comprising:
a processor;
a network interface coupled with the processor; and
means for controlling an immersive lighting structure, which is proximate to and external from a wagering game machine, based, at least in part, on an event communicated over a network and on a configuration of the immersive lighting structure.

15. The apparatus of claim 14 further comprising means for controlling a second immersive lighting structure proximate to and external from a second wagering game machine in coordination with the immersive lighting structure proximate to the wagering game machine.

16. The apparatus of claim 15, wherein the second immersive lighting structure is controlled in accordance with at least one of a lighting scheme for the event and a second lighting scheme customization indicated in a player account associated with the second wagering game machine.

17. The apparatus of claim 16 further comprising means for modifying a default lighting scheme in accordance with player preference data to generate the lighting scheme.

18. The apparatus of claim 14 further comprising means for detecting a player at the wagering game and activating the immersive lighting structure responsive to detecting the player at the wagering game machine.

19. The apparatus of claim 14 further comprising means for detecting the event on the wagering game machine in response to detecting an achievement of at least one specified criterion associated with a wagering game running on the wagering game machine, wherein the event comprises a wagering game-based event.

20. The apparatus of claim 14, wherein said means for controlling the lighting structure comprises means directing a lighting control unit communicatively coupled with the immersive lighting structure to present at least one of dramatic flashes by the immersive lighting structure, light movement between the immersive lighting structure at the wagering game machine and a second immersive lighting structure at a second wagering game machine, a variation of colors and intensity by the immersive lighting structure, and animation by the immersive lighting structure.

21. One or more machine-readable storage media having stored therein instructions for controlling an immersive lighting structure proximate to a wagering game machine but external to the wagering game machine, wherein the instructions, which when executed by a set of one or more processors, causes the set of one or more processors to perform operations that comprise:
determining a configuration of the immersive lighting structure proximate to the wagering game machine responsive to receiving an indication of a wagering game-based event communicated over a network and that corresponds to the wagering game machine;
determining a lighting scheme for the wagering game-based event based, at least in part, on the wagering game-based event and the configuration of the immersive lighting structure; and
directing a lighting control unit to control the immersive lighting structure in accordance with the lighting scheme.

22. The machine-readable storage media of claim 21, wherein the operations further comprise:
detecting the wagering game-based event on the wagering game machine in response to detecting an achievement of specified criteria associated with a wagering game on the wagering game machine.

23. The machine-readable storage media of claim 21, wherein the operations further comprise:
identifying a second wagering game machine at which the wagering game-based event should be indicated; and
directing the lighting control unit to control a second immersive lighting structure that is proximate to a second wagering game machine.

24. The machine-readable storage media of claim 23, wherein the second immersive lighting structure is controlled in accordance with at least one of the lighting scheme and a second lighting scheme customization indicated in a player account associated with the second wagering game machine.

25. The machine-readable storage media of claim 21, wherein the operations further comprise:
determining, for a second wagering game-based event, a second lighting scheme based, at least in part, on player preference data indicated in an account currently associated with the first wagering game machine and on the configuration of the immersive lighting structure; and
directing the lighting control unit to control, in accordance with the second lighting scheme, the immersive lighting structure at the wagering game machine.

26. The machine-readable storage media of claim 25, wherein the operations further comprise modifying a default lighting scheme in accordance with the player preference data to generate the second lighting scheme.

27. The machine-readable storage media of claim 21, wherein the operation of directing the lighting control unit comprises directing the lighting control unit to present at least one of dramatic flashes by the immersive lighting structure, light movement between the immersive lighting structure at the wagering game machine and a second immersive lighting structure at a second wagering game machine, a variation of colors and intensity by the immersive lighting structure, and animation by the immersive lighting structure.

28. The machine-readable storage media of claim 21, wherein the operations further comprise directing the lighting control unit to control, in accordance with the lighting scheme for the wagering game-based event, a lighting structure integrated with a pedestal that supports the wagering game machine.

29. An apparatus that produces lighting effects in accordance with a lighting scheme based, at least in part, on a configuration of an immersive lighting structure and an event communicated over a network, the apparatus comprising:
the immersive lighting structure that comprises a plurality of light source elements coupled with a plurality of reflector elements adapted to cast light onto a wagering game machine and onto an area adjacent to the wagering game machine; and
a pedestal coupled with the immersive lighting structure, the pedestal having a cavity adapted to store items and having at least one light source adapted to cast light onto a wagering game machine supported by the pedestal.

30. The apparatus of claim 29, wherein the pedestal further comprises a pressure sensitive footrest that activates the at least one light source of the pedestal.
